(19) United States
(12) Patent Application Publication
(10) Pub. No.: US 2026/0281988 A1
(43) Pub. Date: Sep. 17, 2026

(54) METHOD AND DEVICE IN A NODE FOR DATA COLLECTION FOR WIRELESS COMMUNICATION

(71) Applicants: Qi JIANG, Shanghai (CN); Lu WU, Shanghai (CN)

(72) Inventors: Qi JIANG, Shanghai (CN); Lu WU, Shanghai (CN)

(73) Assignee: SHANGHAI CODUS TECHNOLOGY COMPANY LIMITED, Shanghai (CN)

(21) Appl. No.: 19/561,554

(22) Filed: Mar. 10, 2026

(30) Foreign Application Priority Data
Mar. 17, 2025 (CN) 202510317502.5

(51) Int. Cl. H04W 72/0446; H04W 76/27

(52) U.S. Cl. CPC H04W 72/0446; H04W 76/27

(57) ABSTRACT

The present application discloses wireless communication data collection. A first node receives a first signaling, which indicates data collection for a first RS resource set; executes a process of the data collection; and transmits a first information block, which includes a first data set, and the first data set depends on measurements performed on the first RS resource set. Executing the process of the data collection includes generating data in the first data set; the process of the data collection occupies processing resources in a first time unit set, which includes at least one time unit; a position of the first time unit set in time domain depends on one of the first information block, the first RS resource set, a data type included in the data collection. This application achieves a balance between resource optimization and performance improvement through more precise management of processing resource occupation.

### CROSS REFERENCE TO RELATED APPLICATIONS

This application claims the priority benefit of Chinese Patent Application No. 202510317502.5, filed on Mar. 17, 2025, the full disclosure of which is incorporated herein by reference.

### BACKGROUND

### Technical Field

This application relates to signal transmission methods and apparatuses in wireless communication systems, and in particular, to a method and apparatus for data collection.

### Related Art

In traditional wireless communications, a UE (User Equipment) reports various auxiliary information obtained through measurements of downlink signals and/or channels, such as channel information, auxiliary information related to Beam Management (BM), auxiliary information related to positioning, HARQ (Hybrid Automatic Repeat reQuest)-ACK (ACKnowledgement) information, beam/radio link failure auxiliary information, and the like. The UE reports the information to a network device, and the network device selects appropriate transmission parameters for the UE based on the UE's report, such as a camping cell, MCS (Modulation and Coding Scheme), TPMI (Transmitted Precoding Matrix Indicator), TCI (Transmission Configuration Indication), and other parameters. In addition, UE reporting can be used to optimize network parameters, such as better cell coverage, switching base stations according to UE positions, and the like.

Application scenarios of future wireless communication systems are becoming increasingly diversified. To meet different performance requirements of different scenarios, 3GPP (3rd Generation Partnership Project) has initiated standard research on RAN (Radio Access Network) intelligence starting from Rel-16 (Release-16), focusing on intelligent use cases, data collection enhancement, potential impacts on RAN nodes and interfaces, and other aspects. In Rel-18, a project on 5G air interface enhancement based on AI/ML was officially established, initiating international standardization work for the integration of 5G air interfaces with AI/ML, focusing on research use cases, Life Cycle Management (LCM), simulation verification, data collection, and other aspects.

Currently, the development of AI/ML has entered the large model stage. Communication large models can realize autonomous networks and intelligent services, support network operation optimization, and improve network efficiency. The deep integration of communication and AI is an important direction for future communication evolution. AI will empower the development and upgrading from 5G and 5.5G to 6G, bringing new management modes such as automated management of frequency bands and traffic, real-time analysis of user data and network load, and prediction of network status.

### SUMMARY

Through researches, the applicant has found that after AI/ML functions are introduced, existing measurement, calculation, and resource occupation may not be able to adapt to the requirements of AI/ML. For example, in the Rel-18 standard, clear definitions of resource occupation and corresponding priority designs are provided for the processing of physical-layer channel information; AI/ML models are based on training, and training data collection is a key step for the effective application of AI/ML in wireless communication networks. The measurement and transmission of a large amount of training data will affect normal communication services. Therefore, how to reasonably define the processing resources occupied during training data collection is a problem that needs to be considered.

To address the above problems, the present application provides a solution. It should be noted that although the original intention of this application is for AI/ML scenarios, this application can also be applied to other non-AI/ML scenarios; further, adopting a unified design solution for different scenarios (such as other non-AI/ML scenarios, including but not limited to V2X (Vehicle to Everything), capacity enhancement systems, short-range communication systems, NTN (Non-Terrestrial Network), IoT (Internet of Things), URLLC (Ultra-Reliable Low-Latency Communication) networks, etc.) helps reduce hardware complexity and cost. In the absence of conflicts, the embodiments and features in the embodiments of this application can be applied to any other node. In the absence of conflicts, the embodiments and features in the embodiments of this application can be combined with each other arbitrarily.

In particular, interpretations of terms, nouns, functions, and variables in the present application (unless otherwise specified) may refer to definitions in TS 38 series and TS 37 series of Technical Specifications (TS) of 3GPP (3 rd Generation Partnership Project). When necessary, reference may be made to TS 38.211, TS 38.212, TS 38.213, TS 38.214, TS 38.215, TS 38.300, TS 38.304, TS 38.305, TS 38.321, TS 38.331, TS 37.355, and TS 38.423 in the 3GPP technical specifications to assist in understanding this application.

In one embodiment, interpretations of terms in the present application refers to definitions in TS 38 series of 3GPP specifications and protocols.

In one embodiment, interpretations of terms in the present application refers to definitions in TS 37 series of 3GPP specifications and protocols.

In one embodiment, interpretations of terms in the present application refers to definitions in Rel-17 version of 3GPP specifications and protocols.

In one embodiment, interpretations of terms in the present application refers to definitions in Rel-18 version of 3GPP specifications and protocols.

The present application provides a method in a first node for data collection in wireless communications, including:
receiving a first signaling, where the first signaling indicates data collection for a first RS resource set;
executing a process of the data collection for the first RS resource set; and
transmitting a first information block, where the first information block includes a first data set, and the first data set depends on measurements in the first RS resource set;
wherein executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and a data type included in the data collection.

In one embodiment, the problems to be solved by this application include: how to determine the time when a UE occupies processing resources when performing data collection.

In one embodiment, the problems to be solved by this application include: how to improve the parallelism of data processing by reasonably arranging resource occupation time.

In one embodiment, the problems to be solved by this application include: how to ensure that the UE completes measurement and data collection on time.

In one embodiment, characteristics of the above method include: this application makes the time of occupying processing resources when performing data collection depend on at least one of the time for transmitting data collected by the data collection, an RS resource set associated with the data collection, and a data type included in the data collection, thereby solving the above problems.

In one embodiment, characteristics of the above method include: the first signaling instructs the first node to start executing the process of the data collection for the first RS resource set.

In one embodiment, characteristics of the above method include: the first data set is used for one or more of model training, model monitoring, and model delivery.

In one embodiment, characteristics of the above method include: the processing resources include at least one of computing resources, storage resources, and inference resources.

In one embodiment, advantages of the above method include: this application supports deep integration of AI and communication, improves the adaptability and intelligence level of the communication system, and further improves the performance, efficiency, and user experience of the communication system.

In one embodiment, advantages of the above method include: defining the time when the data collection process occupies processing resources, ensuring that the data collection process is completed within a specified time, and improving the manageability of computing tasks.

In one embodiment, advantages of the above method include: making the time when the data collection process occupies processing resources depend on the data type included in the data collection to adapt to processing schemes of different data types and optimize computing resource allocation.

In one embodiment, advantages of the above method include: helping the UE release processing resources in a timely manner after completing computing, and improving resource utilization.

In one embodiment, advantages of the above method include: achieving a balance between computing accuracy and computing complexity, and avoiding computing overload.

In one embodiment, advantages of the above method include: by clearly specifying the time of processing resources occupied by data collection, the UE can plan computing resource allocation in advance to avoid affecting other key physical layer operations.

According to one aspect of this application, the above method is characterized in that the first time unit set occupies continuous time-domain resources, a start of the first time unit set is not earlier than a first one of symbols of an earliest RS resource in the first RS resource set after the first signaling takes effect, the first time unit set ends at a first moment, and the first moment depends on the first information block.

In one embodiment, characteristics of the above method include: the process of the data collection for the first RS resource set occupies a same amount of processing resources in the first time unit set.

In one embodiment, characteristics of the above method include: time-domain resources occupied by the first time unit set are not earlier than the first signaling being applied.

In one embodiment, characteristics of the above method include: a start moment of the first time unit set depends on the first RS resource set, and an end moment of the first time unit set depends on at least the first information block.

In one embodiment, advantages of the above method include: providing a longer time window for the first node to ensure that the first node can completely receive and process multiple RS resources during the entire measurement period.

In one embodiment, advantages of the above method include: unifying the measurement start point, establishing a consensus between the base station and the terminal, and ensuring computing consistency.

In one embodiment, advantages of the above method include: starting from a first one of symbols of an earliest RS resource helps maximize the measurement time, improve measurement accuracy, and avoid computing delay.

According to one aspect of this application, the above method is characterized in that the first moment is a last one of symbols of a physical-layer channel occupied by the first information block.

In one embodiment, characteristics of the above method include: the first moment is a last one of symbols of a physical-layer channel for transmitting the first data set.

In one embodiment, advantages of the above method include: ending the occupation of processing resources after transmitting the first information block helps avoid incomplete measurement information and improve measurement accuracy.

In one embodiment, advantages of the above method include: maximizing the measurement period to ensure that processing resources are not released before the first data set is reported.

In one embodiment, advantages of the above method include: avoiding problems such as reduced measured RS resources and decreased processing accuracy caused by early release of processing resources.

According to one aspect of this application, the above method includes:
receiving a second signaling;
wherein the second signaling schedules the first information block, or the second signaling instructs to deactivate the process of the data collection for the first RS resource set; the first moment is Y time-domain resource units after a last one of symbols of a physical-layer channel occupied by the second signaling; the Y depends on a data type included in the data collection, and the Y is a positive integer greater than 1.

In one embodiment, characteristics of the above method include: the second signaling is a MAC CE, or the second signaling instructs to deactivate/stop/end the process of the data collection for the first RS resource set, or the second signaling is UL DCI, and the second signaling schedules a physical-layer channel occupied by the first information block.

In one embodiment, characteristics of the above method include: the Y time-domain resource units depend on a capability of the first node.

In one embodiment, characteristics of the above method include: the Y time-domain resource units are a lower limit of computing processing delay of the first node.

In one embodiment, advantages of the above method include: making the Y time-domain resource units depend on the data type included in the data collection to ensure that the first node has sufficient time to complete measurement and computing of data collection for different data types.

In one embodiment, advantages of the above method include: optimizing processing resource allocation, helping the first node complete measurement and computing while releasing processing resources in a timely manner, and avoiding redundancy or waste of processing resources.

In one embodiment, advantages of the above method include: defining an end buffer to prevent sudden computing tasks from affecting scheduling.

According to one aspect of this application, the above method is characterized in that time units included in the first time unit set are periodic; each time unit in the first time unit set starts at a first one of symbols of an earliest RS resource in each given period, and ends at X time-domain resource units after a last one of symbols of a latest RS resource in each given period; the X is a positive integer greater than 1.

In one embodiment, the problem to be solved by this application includes: how to achieve more accurate processing resource occupation management.

In one embodiment, characteristics of the above method include: compared with existing CSI computing processing, data collection requires a longer time to collect more data; if processing resources are occupied continuously for a long time, CSI computing and feedback may time out due to processing resource preemption; in the present application, when the first node performs data collection, the occupation of processing resources during measurement and computing is determined according to the targeted RS resource set, thereby achieving more accurate processing resource occupation management and solving the above problem.

In one embodiment, characteristics of the above method include: the process of the data collection for the first RS resource set occupies a same amount of processing resources in each time unit of the first time unit set.

In one embodiment, characteristics of the above method include: the first node starts the process of the data collection for the first RS resource set in each time unit included in the first time unit set.

In one embodiment, advantages of the above method include: by allocating processing resources in a periodic manner, the first node can complete data collection without affecting other tasks, improving system flexibility.

In one embodiment, advantages of the above method include: training data usually needs to extract features from data of multiple periods, so occupying processing resources in a given period can reduce computing resource consumption and improve processing efficiency.

In one embodiment, advantages of the above method include: achieving more accurate processing resource occupation management and reducing energy consumption.

According to one aspect of this application, the above method is characterized in that the X depends on the data type included in the data collection.

In one embodiment, characteristics of the above method include: the X time-domain resource units depend on a capability of the first node.

In one embodiment, characteristics of the above method include: the X time-domain resource units are a lower limit of computing processing delay of the first node.

In one embodiment, advantages of the above method include: making the X time-domain resource units depend on the data type included in the data collection to ensure that the first node has sufficient time to complete measurement and computing of data collection for different data types.

In one embodiment, advantages of the above method include: optimizing processing resource allocation, helping the first node complete measurement and computing while releasing processing resources in a timely manner, and avoiding redundancy or waste of processing resources.

In one embodiment, advantages of the above method include: considering computing buffer, adapting to terminal computing capabilities, and reducing terminal computing burden.

According to one aspect of this application, the above method is characterized in that a length of the given period is configured by a higher-layer signaling, or a length of the given period depends on the data type included in the data collection.

In one embodiment, characteristics of the above method include: the given period depends on a period of the first RS resource set, and the period of the first RS resource set is configured by higher-layer signaling.

In one embodiment, characteristics of the above method include: the data type included in the data collection is used to select the given period from multiple candidate periods.

In one embodiment, characteristics of the above method include: a period for executing the data collection process depends on the given period.

In one embodiment, advantages of the above method include: making the given period depend on the data type included in the data collection can adapt to different data types, enrich measurement modes, and improve flexibility.

In one embodiment, advantages of the above method include: configuration by higher-layer signaling reduces implementation complexity and is conducive to deployment and commercialization.

In one embodiment, advantages of the above method include: good compatibility.

According to one aspect of this application, the above method is characterized in that candidates for data types included in the data collection include at least one of CSI, position-related information, decoding information, and mobility management-related information.

In one embodiment, characteristics of the above method include: the CSI includes one or more of CRI, SSBRI, L1-RSRP, L1-SINR, CRI, RI, PMI, CQI, and LI.

In one embodiment, characteristics of the above method include: candidates for the data types include an AI inference indication.

In one embodiment, advantages of the above method include: including multiple data types in a same data set enables the terminal to transmit the multiple data types through one transmission, reducing air interface resource overhead.

In one embodiment, advantages of the above method include: good compatibility.

In one embodiment, advantages of the above method include: the UE can collect data of multiple data types, making model training and inference of AI/ML more matched, and further improving the performance of the AI/ML solution.

According to one aspect of this application, the above method is characterized in that the first node is a user equipment.

According to one aspect of this application, the above method is characterized in that the first node is a terminal.

The present application provides a method in a second node for data collection in wireless communications, including:
transmitting a first signaling, where the first signaling indicates data collection for a first RS resource set; and
receiving a first information block, where the first information block includes a first data set, and the first data set depends on measurements performed by a receiver of the first signaling in the first RS resource set;
wherein a receiver of the first signaling executes a process of the data collection for the first RS resource set; executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and a data type included in the data collection.

In one embodiment, characteristics of the above method include: the second node includes a base station and a core network.

In one embodiment, characteristics of the above method include: the second node includes a core network.

In one embodiment, characteristics of the above method include: the second node includes an entity for deploying an AI/ML model.

In one embodiment, characteristics of the above method include: the second node includes a node for deploying an AI/ML model.

In one embodiment, characteristics of the above method include: the second node includes a base station.

In one embodiment, characteristics of the above method include: the second node is a base station.

In one embodiment, characteristics of the above method include: the second node is an LMF.

In one embodiment, characteristics of the above method include: the second node is an OAM.

In one embodiment, characteristics of the above method include: the second node is a gNB.

In one embodiment, characteristics of the above method include: the second node is a network device, and the network device includes at least one of a core network device and an access network device.

In one embodiment, characteristics of the above method include: the second node is a device that provides wireless communication function services and can communicate with terminal devices, and typically resides on the network side.

In one embodiment, characteristics of the above method include: the base station in the present application includes a core network.

In one embodiment, characteristics of the above method include: the base station in the present application includes a core network device.

In one embodiment, characteristics of the above method include: the base station in the present application includes an entity for deploying an AI/ML model.

In one embodiment, characteristics of the above method include: the base station in the present application includes a node for deploying an AI/ML model.

According to one aspect of this application, the above method is characterized in that the first time unit set occupies continuous time-domain resources, a start of the first time unit set is not earlier than a first one of symbols of an earliest RS resource in the first RS resource set after the first signaling takes effect, the first time unit set ends at a first moment, and the first moment depends on the first information block.

According to one aspect of this application, the above method is characterized in that the first moment is a last one of symbols of a physical-layer channel occupied by the first information block.

According to one aspect of this application, the above method includes:
transmitting a second signaling;
wherein the second signaling schedules the first information block, or the second signaling instructs to deactivate the process of the data collection for the first RS resource set; the first moment is Y time-domain resource units after a last one of symbols of a physical-layer channel occupied by the second signaling; the Y depends on a data type included in the data collection, and the Y is a positive integer greater than 1.

According to one aspect of this application, the above method is characterized in that time units included in the first time unit set are periodic; each time unit in the first time unit set starts at a first one of symbols of an earliest RS resource in each given period, and ends at X time-domain resource units after a last one of symbols of a latest RS resource in each given period; the X is a positive integer greater than 1.

According to one aspect of this application, the above method is characterized in that the X depends on a data type included in the data collection.

According to one aspect of this application, the above method is characterized in that a length of the given period is configured by a higher-layer signaling, or a length of the given period depends on a data type included in the data collection.

According to one aspect of this application, the above method is characterized in that candidates for data types included in the data collection include at least one of CSI, position-related information, decoding information, and mobility management-related information.

According to one aspect of this application, the above method is characterized in that the second node is a base station.

The present application provides a first node for data collection in wireless communications, including:
a first receiver configured to receive a first signaling, where the first signaling indicates data collection for a first RS resource set; and execute a process of the data collection for the first RS resource set; and
a first transmitter configured to transmit a first information block, where the first information block includes a first data set, and the first data set depends on measurements performed on the first RS resource set;
wherein executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and a data type included in the data collection.

The present application provides a second node for data collection in wireless communications, including:
a second transmitter configured to transmit a first signaling, where the first signaling indicates data collection for a first RS resource set; and
a second receiver configured to receive a first information block, where the first information block includes a first data set, and the first data set depends on measurements performed by a receiver of the first signaling in the first RS resource set;
wherein a receiver of the first signaling executes a process of the data collection for the first RS resource set; executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and a data type included in the data collection.

In one embodiment, compared with traditional solutions, this application has the following advantageous but non-limiting advantages:

This application supports deep integration of AI and communication, improves the adaptability and intelligence level of the communication system, and further improves the performance, efficiency, and user experience of the communication system;

Adapts to measurement modes of different data types, improves flexibility, and avoids conflicts with existing measurement tasks;

Solves the problem of resource occupation time for the UE to perform data collection, achieves more accurate processing resource occupation management, reduces power consumption, improves the parallelism of processing resources and thus the utilization rate of processing resources, helps AI deployment, and improves the overall performance of the system;

In the case of limited computing resources, efficiently completes data collection while ensuring the normal operation of other key physical layer tasks, achieving a balance between resource optimization and performance improvement.

### BRIEF DESCRIPTION OF THE DRAWINGS

Other features, objectives, and advantages of this application will become more apparent by reading the detailed description of non-limiting embodiments with reference to the following drawings:

FIG. 1 illustrates a flowchart of transmission by a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of transmission between a first node and a second node according to one embodiment of the present application;

FIG. 6 illustrates a schematic diagram of a start moment of a first time unit set according to one embodiment of the present application;

FIG. 7 illustrates a first schematic diagram of a first moment according to one embodiment of the present application;

FIG. 8 illustrates a second schematic diagram of a first moment according to one embodiment of the present application;

FIG. 9 illustrates a schematic diagram of a given period according to one embodiment of the present application;

FIG. 10 illustrates a schematic diagram of time-domain resources of a period occupied by a first time unit set according to one embodiment of the present application;

FIG. 11 illustrates a schematic diagram of data types included in data collection according to one embodiment of the present application;

FIG. 12 illustrates a schematic diagram of RAN domain AI/ML function deployment according to one embodiment of the present application;

FIG. 13 illustrates a schematic diagram of UE AI/ML function deployment according to one embodiment of the present application;

FIG. 14 illustrates a schematic diagram of a processing system based on artificial intelligence or machine learning according to one embodiment of the present application;

FIG. 15 illustrates a schematic diagram of artificial intelligence or machine learning according to one embodiment of the present application;

FIG. 16 illustrates a structural block diagram of a processor in a first node according to one embodiment of the present application;

FIG. 17 illustrates a structural block diagram of a processor in a second node according to one embodiment of the present application.

### DESCRIPTION OF THE EMBODIMENTS

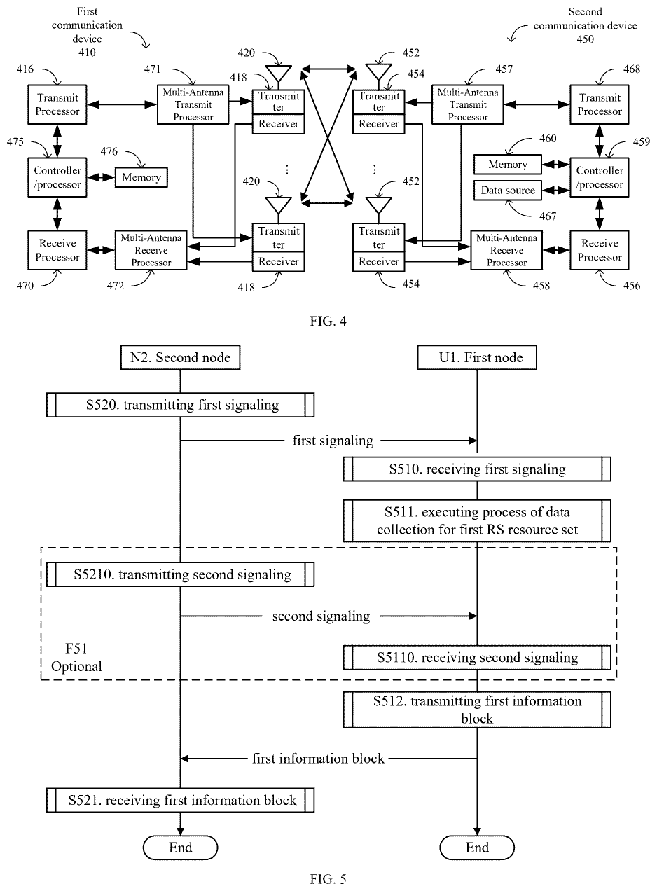

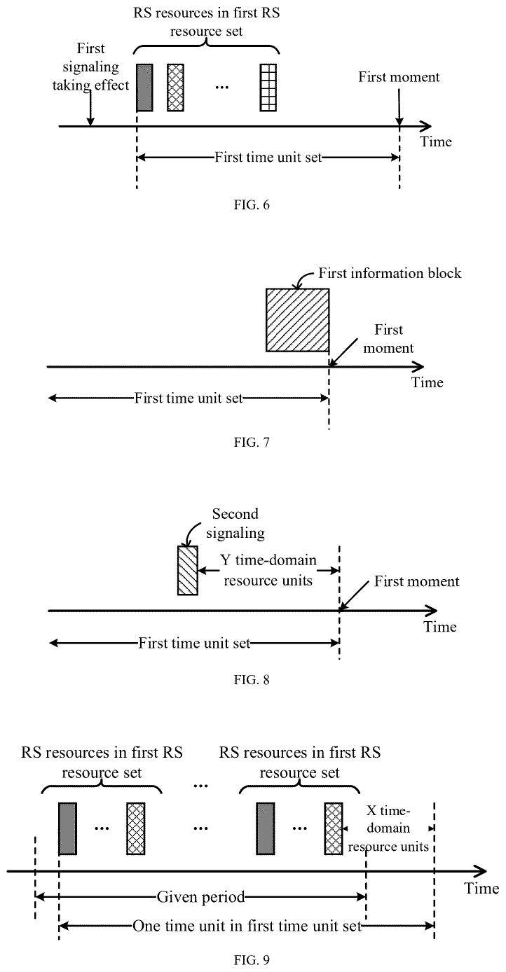

The technical solutions of the present application will be described in further detail below with reference to the accompanying drawings. It should be noted that, in the absence of conflicts, the embodiments and features in the embodiments of the present application may be combined with each other arbitrarily. Based on considerations of performance, flexibility, complexity, overhead, compatibility, and the like, those skilled in the art are motivated to flexibly combine the embodiments in different figures without contradiction, including but not limited to the embodiment in FIG. 1 and the embodiments in FIGS. 5-17, the embodiment in FIG. 5 and the embodiments in FIGS. 6-17, and so on.

### Embodiment 1

Embodiment 1 illustrates a flowchart of transmission by a first node according to one embodiment of the present application, as shown in FIG. 1. In FIG. 1, each block represents a step. In particular, the order of the steps in the blocks does not represent a specific chronological relationship between the steps.

The first node receives a first signaling in step 101, where the first signaling indicates data collection for a first RS resource set; executes a process of the data collection for the first RS resource set in step 102; and transmits a first information block in step 103, where the first information block includes a first data set, and the first data set depends on measurements in the first RS resource set.

In Embodiment 1, executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and a data type included in the data collection.

In one embodiment, the first node is a User Equipment (UE).

In one embodiment, the first node is a terminal.

In one embodiment, the first node in the present application includes a core network device that provides services for terminal AI.

In one embodiment, the first node in the present application includes an application layer device that provides services for terminal AI.

In one embodiment, the first node in the present application includes an Agent that provides services for terminal AI.

In one embodiment, the first node in the present application includes a Handset.

In one embodiment, the first node is the first node in the present application.

In one embodiment, the RS refers to: Reference Signal.

In one embodiment, the first node receives the first signaling.

In one embodiment, the first signaling is carried by a higher layer signaling.

In one embodiment, the first signaling is transmitted through a Radio Resource Control (RRC) signaling.

In one embodiment, the first signaling includes one or more RRC Information Elements (IEs).

In one embodiment, the first signaling includes one or more fields in one RRC IE.

In one embodiment, the first signaling includes information in one or more fields of each of multiple RRC IEs.

In one embodiment, the first signaling is one RRC IE.

In one embodiment, the first signaling includes a ServingCellConfig IE.

In one embodiment, the first signaling includes one or more fields in a ServingCellConfig IE.

In one embodiment, the first signaling includes a CSI-MeasConfig IE.

In one embodiment, the first signaling includes one or more fields in a CSI-MeasConfig IE.

In one embodiment, the first signaling includes an NZP-CSI-RS-Resource IE.

In one embodiment, the first signaling includes one or more fields in an NZP-CSI-RS-Resource IE.

In one embodiment, the first signaling includes an NZP-CSI-RS-ResourceSet IE.

In one embodiment, the first signaling includes one or more fields in an NZP-CSI-RS-ResourceSet IE.

In one embodiment, the first signaling includes a CSI-IM-Resource IE.

In one embodiment, the first signaling includes one or more fields in a CSI-IM-Resource IE.

In one embodiment, the first signaling includes a CSI-IM-ResourceSet IE.

In one embodiment, the first signaling includes one or more fields in a CSI-IM-ResourceSet IE.

In one embodiment, the first signaling includes a CSI-SSB-ResourceSet IE.

In one embodiment, the first signaling includes one or more fields in a CSI-SSB-ResourceSet IE.

In one embodiment, the first signaling includes a CSI-ResourceConfig IE.

In one embodiment, the first signaling includes one or more fields in a CSI-ResourceConfig IE.

In one embodiment, the first signaling includes a MeasConfig IE.

In one embodiment, the first signaling includes one or more fields in a MeasConfig IE.

In one embodiment, the first signaling includes a MeasObjectToAddModList IE.

In one embodiment, the first signaling includes one or more fields in a MeasObjectToAddModList IE.

In one embodiment, the first signaling includes one or more fields in a MeasObject IE.

In one embodiment, the first signaling includes a MeasObjectNR IE.

In one embodiment, the first signaling includes a MeasObject6G IE.

In one embodiment, the first signaling includes a MeasObject6G IE.

In one embodiment, the first signaling includes a CSI-RS-ResourceConfigMobility IE.

In one embodiment, the first signaling includes one or more fields in a CSI-RS-ResourceConfigMobility IE.

In one embodiment, a name of an RRC signaling used to transmit the first signaling includes CSI.

In one embodiment, a name of an RRC signaling used to transmit the first signaling includes CSI-RS.

In one embodiment, a name of an RRC signaling used to transmit the first signaling includes Config.

In one embodiment, a name of an RRC signaling used to transmit the first signaling includes Meas.

In one embodiment, a name of an RRC signaling used to transmit the first signaling includes Measurement.

In one embodiment, a name of an RRC signaling used to transmit the first signaling includes Object.

In one embodiment, a name of an RRC signaling used to transmit the first signaling includes Data.

In one embodiment, a name of an RRC signaling used to transmit the first signaling includes DataSet.

In one embodiment, a name of an RRC signaling used to transmit the first signaling includes Collection.

In one embodiment, a name of an RRC signaling used to transmit the first signaling includes Collect.

In one embodiment, a name of an RRC signaling used to transmit the first signaling includes Training.

In one embodiment, the first signaling includes a dynamic signaling.

In one embodiment, the first signaling includes a control signaling.

In one embodiment, the first signaling is a Medium Access Control (MAC) layer signaling.

In one embodiment, the first signaling is a MAC layer control signaling.

In one embodiment, the first signaling is a MAC Control Element (CE) signaling.

In one embodiment, the first signaling is an activation command.

In one embodiment, the first signaling includes an SP CSI-RS/CSI-IM Resource Set Activation/Deactivation MAC CE.

In one embodiment, the first signaling includes an SP ZP CSI-RS Resource Set Activation/Deactivation MAC CE.

In one embodiment, a name of a MAC CE carrying the first signaling includes: Activation.

In one embodiment, a name of a MAC CE carrying the first signaling includes: Deactivation.

In one embodiment, a name of a MAC CE carrying the first signaling includes: Data.

In one embodiment, a name of a MAC CE carrying the first signaling includes: Collection.

In one embodiment, a name of a MAC CE carrying the first signaling includes: Collect.

In one embodiment, a name of a MAC CE carrying the first signaling includes: Resource.

In one embodiment, a name of a MAC CE carrying the first signaling includes: AI.

In one embodiment, a name of a MAC CE carrying the first signaling includes: ML.

In one embodiment, a name of a MAC CE carrying the first signaling includes: Training.

In one embodiment, the first RS resource set includes at least one RS.

In one embodiment, the first RS resource set includes at least one RS resource.

In one embodiment, the first RS resource set includes downlink RS resources.

In one embodiment, the first RS resource set includes RS resources for time-frequency resource tracking.

In one embodiment, the first RS resource set includes Phase-Tracking Reference Signal (PTRS) resources.

In one embodiment, the first RS resource set includes RS resources for positioning.

In one embodiment, the first RS resource set includes Positioning Reference Signal (PRS) resources.

In one embodiment, the first RS resource set includes RS resources for channel estimation.

In one embodiment, the first RS resource set includes RS resources for demodulation.

In one embodiment, the first RS resource set includes DeModulation Reference Signal (DMRS) resources.

In one embodiment, the first RS resource set includes RS resources for sensing.

In one embodiment, the first RS resource set includes RS resources for Integrated Sensing And Communication (ISAC).

In one embodiment, the first RS resource set includes ISAC-RS resources.

In one embodiment, the first RS resource set includes ISAC Reference Signal (IRS) resources.

In one embodiment, the first RS resource set includes RS resources for Mobility management.

In one embodiment, the first RS resource set includes RS resources for Cell-level mobility management.

In one embodiment, the first RS resource set includes RS resources for Beam-level mobility management.

In one embodiment, the first RS resource set includes RS resources for synchronization.

In one embodiment, the first RS resource set includes at least a Synchronization Signal (SS).

In one embodiment, the first RS resource set includes at least a synchronization signal in a 5G system and systems after the 5G system.

In one embodiment, the first RS resource set includes at least a synchronization signal in a 6G system.

In one embodiment, the first RS resource set includes at least a Primary Synchronization Signal (PSS).

In one embodiment, the first RS resource set includes at least a Secondary Synchronization Signal (SSS).

In one embodiment, the first RS resource set includes at least a Physical Broadcast CHannel (PBCH).

Typically, occasions for receiving the PBCH, the PSS, and the SSS are in consecutive symbols and form an SS/PBCH block.

In one embodiment, any RS resource in the first RS resource set is a CSI-RS resource or an SSB resource.

In one embodiment, any RS resource in the first RS resource set is identified by an NZP-CSI-RS-ResourceId or an SSB-Index.

In one embodiment, the first RS resource set is identified by a CSI-ResourceConfigId.

In one embodiment, the first RS resource set is a CSI-RS resource set.

In one embodiment, the first RS resource set is a Non-Zero-Power (NZP) CSI-RS resource set.

In one embodiment, the first RS resource set is a CSI-SSB resource set.

In one embodiment, each RS resource in the first RS resource set is a CSI-RS resource.

In one embodiment, each RS resource in the first RS resource set is an NZP CSI-RS resource.

In one embodiment, each RS resource in the first RS resource set is identified by an NZP-CSI-RS-ResourceId.

In one embodiment, the first RS resource set includes an SSB.

In one embodiment, the first RS resource set includes SSB resources.

In one embodiment, the first RS resource set includes at least one SSB.

In one embodiment, the first RS resource set includes one SSB.

In one embodiment, the first RS resource set includes multiple SSBs.

In one embodiment, the first RS resource set includes SSBs in at least one SSB burst.

In one embodiment, each RS resource in the first RS resource set is identified by an SSB-Index.

In one embodiment, each RS resource in the first RS resource set is an SSB resource.

In one embodiment, the SSB in the present application refers to: Synchronization Signal Block.

In one embodiment, the SSB in the present application refers to: SS/PBCH block.

In one embodiment, RS resources in the first RS resource set belong to a same cell.

In one embodiment, two RS resources in the first RS resource set belong to different cells.

In one embodiment, RS resources in the first RS resource set belong to a same BandWidth Part (BWP).

In one embodiment, two RS resources in the first RS resource set belong to different BWPs.

In one embodiment, each RS resource in the first RS resource set includes at least one port.

In one embodiment, each RS resource in the first RS resource set includes at least one antenna port.

In one embodiment, each RS resource in the first RS resource set includes at least one RS port.

In one embodiment, each RS resource in the first RS resource set includes Channel State Information Reference Signal (CSI-RS) ports.

In one embodiment, the first RS resource set is periodic.

In one embodiment, the first RS resource set includes periodic RS resources.

In one embodiment, the first RS resource set is Semi-Persistent (SP).

In one embodiment, the first RS resource set includes semi-persistent RS resources.

In one embodiment, the first signaling indicates data collection for the first RS resource set.

In one embodiment, the first signaling indicates the first RS resource set.

In one embodiment, the first signaling configures the first RS resource set.

In one embodiment, the first signaling indicates an identifier of the first RS resource set.

In one embodiment, an identifier of the first RS resource set is an NZP-CSI-RS-ResourceSetId.

In one embodiment, an identifier of the first RS resource set is a CSI-SSB-ResourceSetId.

In one embodiment, an identifier of the first RS resource set is a CSI-ResourceConfigId.

In one embodiment, an identifier of the first RS resource set is an SSB-Index.

In one embodiment, an identifier of the first RS resource set is an NZP-CSI-RS-ResourceSetId or a CSI-SSB-ResourceSetId.

In one embodiment, the first signaling indicates an identifier of each RS resource in the first RS resource set.

In one embodiment, an identifier of each RS resource in the first RS resource set is an NZP-CSI-RS-ResourceId.

In one embodiment, an identifier of each RS resource in the first RS resource set is an SSB-Index.

In one embodiment, an identifier of any RS resource in the first RS resource set is an NZP-CSI-RS-ResourceId or an SSB-Index.

In one embodiment, the first signaling instructs to activate a process of data collection for the first RS resource set.

In one embodiment, the first signaling instructs to start a process of data collection for the first RS resource set.

In one embodiment, the first signaling instructs to activate the first RS resource set.

In one embodiment, the first signaling indicates an identifier of a process of data collection for the first RS resource set.

In one embodiment, the first signaling indicates an identifier of the first data set.

In one embodiment, the first node executes the process of the data collection for the first RS resource set.

In one embodiment, the first node executing the process of the data collection for the first RS resource set includes: the first node performing measurements in the first RS resource set.

In one embodiment, the first node executing the process of the data collection for the first RS resource set includes: the first node measuring the first RS resource set to obtain data required for the data collection.

In one embodiment, the first node executing the process of the data collection for the first RS resource set includes: the first node partially storing data obtained by measurements in the first RS resource set.

In one embodiment, the first node executing the process of the data collection for the first RS resource set includes: the first node storing data required for the data collection obtained by measurements in the first RS resource set.

In one embodiment, the first node executing the process of the data collection for the first RS resource set includes: in a given period in the present application, the first node performing measurements in the first RS resource set.

In one embodiment, the first node executing the process of the data collection for the first RS resource set includes: in a given period in the present application, the first node measuring the first RS resource set to obtain data required for the data collection.

In one embodiment, the first node executing the process of the data collection for the first RS resource set includes: in a given period in the present application, the first node partially storing data obtained by measurements in the first RS resource set.

In one embodiment, the first node executing the process of the data collection for the first RS resource set includes: in a given period in the present application, the first node storing data required for the data collection obtained by measurements in the first RS resource set.

In one embodiment, the first node executing the process of the data collection for the first RS resource set includes: the first node generating the first data set.

In one embodiment, the first node executing the process of the data collection for the first RS resource set includes: the first node transmitting the first data set.

In one sub-embodiment of the embodiment, the transmitting includes transmitting to a higher layer of the first node.

In one sub-embodiment of the embodiment, the transmitting includes transmitting to the second node in the present application.

In one embodiment, after the first signaling takes effect, the first node executes the process of the data collection for the first RS resource set.

In one embodiment, in response to receiving the first signaling, the first node executes the process of the data collection for the first RS resource set.

In one embodiment, in response to the first signaling taking effect, the first node executes the process of the data collection for the first RS resource set.

In one embodiment, in response to the first signaling being applied, the first node executes the process of the data collection for the first RS resource set.

In one embodiment, the first node transmits the first information block.

In one embodiment, the first information block is carried by a UEInformationResponse message.

In one embodiment, the first information block is carried by a UEAssistanceInformation message.

In one embodiment, the first information block is carried by a MeasurementReport message.

In one embodiment, the first information block is carried by a MeasurementReportAppLayer message.

In one embodiment, the first information block is transmitted through a Non-Access Stratum (NAS) signaling.

In one embodiment, the first information block includes the first data set.

In one embodiment, the first information block carries the first data set.

In one embodiment, the first data set is used for model training.

In one embodiment, the first data set is used for model verification.

In one embodiment, the first data set is used for model testing.

In one embodiment, the first data set is associated with the inference configuration.

In one embodiment, the first data set is associated with a functionality.

In one embodiment, the first data set is associated with an AI model.

In one embodiment, the first data set is associated with a reporting configuration.

In one embodiment, the first data set is associated with an Associated ID.

In one embodiment, the Associated ID in the present application is a non-negative integer.

In one embodiment, the Associated ID in the present application is a positive integer.

In one embodiment, the Associated ID in the present application is a string.

In one embodiment, the Associated ID in the present application is an association ID.

In one embodiment, the Associated ID in the present application is an Associated ID.

In one embodiment, the Associated ID in the present application is an Associated-Id.

In one embodiment, the Associated ID in the present application identifies a functionality.

In one embodiment, the Associated ID in the present application is used to indicate the generalization capability of a model.

In one embodiment, the Associated ID in the present application is used to ensure consistency of Network-side (NW-side) additional conditions during model training and model inference processes.

In one embodiment, multiple beams, multiple beam sets, or multiple beam lists associated with the same Associated ID in the present application have similar properties.

In one embodiment, a buffer for storing data required for the data collection is an Access Stratum (AS) buffer.

In one embodiment, the first data set depends on measurements performed by the first node in the first RS resource set.

In one embodiment, the first data set includes data obtained by measurements in the first RS resource set.

In one embodiment, the first data set includes partial data obtained by measurements in the first RS resource set.

In one embodiment, the first data set includes at least first channel information, and candidates included in the first channel information include Reference Signal Received Power (RSRP), Reference Signal Receiving Quality (RSRQ), Signal-to-Interference and Noise Ratio (SINR), Received Signal Strength Indication (RSSI), Channel Quality Indicator (CQI), Precoding Matrix Indicator (PMI), and Rank Indicator (RI).

In one embodiment, the measurements in the first RS resource set include: measuring RS transmitted on RS resources included in the first RS resource set.

In one embodiment, the measurements in the first RS resource set include: performing measurements on RS transmitted on RS resources included in the first RS resource set.

In one embodiment, the measurements in the first RS resource set include: performing measurements on RS transmitted on partial RS resources included in the first RS resource set.

In one embodiment, the measurements include: Intra-frequency measurements.

In one embodiment, the measurements include: Inter-frequency measurements.

In one embodiment, the measurements include: Inter-Radio Access Technology (Inter-RAT) measurements.

In one embodiment, the measurements include: Intra-Radio Access Technology (Intra-RAT) measurements.

In one embodiment, the measurements include: channel measurement.

In one embodiment, the measurements include: receive power measurement.

In one embodiment, the measurements include: RSRP measurement.

In one embodiment, the measurements include: Path Loss (PL) measurement.

In one embodiment, the measurements include: channel matrix measurement.

In one embodiment, the measurements include: raw channel matrix measurement.

In one embodiment, the measurements include: eigenvector and eigenvalue measurement.

In one embodiment, the measurements include: BLock Error Rate (BLER) measurement.

In one embodiment, the measurements include: delay spread measurement.

In one embodiment, the measurements include: Doppler shift measurement.

In one embodiment, the measurements include: Doppler spread measurement.

In one embodiment, the measurements include: average delay measurement.

In one embodiment, the measurements include: average gain measurement.

In one embodiment, the measurements include: interference measurement.

In one embodiment, the measurements include: interference channel matrix measurement.

In one embodiment, the measurements include: interference covariance matrix measurement.

In one embodiment, the measurements include: interference eigenvector measurement.

In one embodiment, the measurements include: interference eigenvalue measurement.

In one embodiment, the measurements include: interference beam measurement.

In one embodiment, the measurements include: interference power measurement.

In one embodiment, the measurements include: interference variance measurement.

In one embodiment, the measurements include: interference power spectral density measurement.

In one embodiment, executing the process of the data collection for the first RS resource set includes generating data in the first data set.

In one embodiment, executing the process of the data collection for the first RS resource set generates the first data set.

In one embodiment, executing the process of the data collection for the first RS resource set generates partial data in the first data set.

In one embodiment, executing the process of the data collection for the first RS resource set includes generating data included in the first data set by measuring and calculating the first RS resource set.

In one embodiment, partial or all data in the first data set depends on the process of the data collection for the first RS resource set.

In one embodiment, the process of the data collection for the first RS resource set occupies processing resources in the first time unit set.

In one embodiment, in time-domain resources included in a first time unit set, the process of the data collection for the first RS resource set occupies processing resources.

In one embodiment, the process of the data collection for the first RS resource set only occupies processing resources in the first time unit set.

In one embodiment, the first node executes the process of the data collection for the first RS resource set in time-domain resources included in the first time unit set.

In one embodiment, a time when the first node executes the process of the data collection for the first RS resource set belongs to time-domain resources included in the first time unit set.

In one embodiment, the first node does not execute the process of the data collection for the first RS resource set in time-domain resources outside those included in the first time unit set.

In one embodiment, the first node executes the process of the data collection for the first RS resource set in each time unit of the first time unit set.

In one embodiment, the processing resources occupied by the process of the data collection for the first RS resource set include a Neural network Processing Unit (NPU).

In one embodiment, the processing resources occupied by the process of the data collection for the first RS resource set include a Data Processing Unit (DPU).

In one embodiment, the processing resources occupied by the process of the data collection for the first RS resource set include a CPU.

In one embodiment, the CPU in the present application is: CSI Processing Unit.

In one embodiment, the CPU in the present application is: Central Processing Unit.

Typically, the processing resources occupied by the process of the data collection only include computing resources.

In one embodiment, the processing resources include resources required for computing.

In one embodiment, the processing resources include computing power resources.

In one embodiment, the processing resources are used for at least one of processing, computing, or measurement.

In one embodiment, the processing resources are used for at least addition and multiplication operations.

In one embodiment, one the processing resource is a calculation unit.

In one embodiment, one the processing resource is a channel information generation unit.

In one embodiment, one the processing resource is a beam information generation unit.

In one embodiment, one the processing resource is an Arithmetic and Logic Unit (ALU).

In one embodiment, one the processing resource is a Special Function Unit (SFU).

Typically, the processing resources occupied by the process of the data collection include computing resources and storage resources.

In one embodiment, the processing resources include the storage resources.

In one embodiment, the processing resources include bandwidth of a memory.

In one embodiment, the processing resources include cache resources.

In one embodiment, the processing resources include bandwidth resources.

In one embodiment, the processing resources include read/write resources.

In one embodiment, the processing resources include cache resources.

In one embodiment, the processing resources include register resources.

In one embodiment, the processing resources include data interaction resources.

In one embodiment, the processing resources include resources required for storage.

In one embodiment, the processing resources include resources required for reading and writing.

In one embodiment, the processing resources include resources required for process control.

In one embodiment, the processing resources are used for storage.

In one embodiment, the processing resources are used for reading and writing.

In one embodiment, the processing resources are used for data interaction.

In one embodiment, one the processing resource includes a part of each level of storage resources in multi-level storage resources.

In one embodiment, one the processing resource is a storage unit.

In one embodiment, one the processing resource is a cache resource.

In one embodiment, one the processing resource is a register.

In one embodiment, one the processing resource includes at least one register.

In one embodiment, the first time unit set includes at least one time unit.

In one embodiment, the first time unit set includes one time unit.

In one embodiment, the first time unit set includes multiple time units.

In one embodiment, the time unit in the present application is a subframe.

In one embodiment, the time unit in the present application is a slot.

In one embodiment, the time unit in the present application is a symbol.

In one embodiment, the time unit in the present application includes one or more slots.

In one embodiment, the time unit in the present application includes one or more subframes.

In one embodiment, the time unit in the present application includes one or more symbols.

In one embodiment, the time unit in the present application includes continuous time-domain resources.

In one embodiment, the first time unit set includes continuous time-domain resources.

In one embodiment, the first time unit set includes periodic time-domain resources.

In one embodiment, each time unit in the first time unit set includes orthogonal time-domain resources.

In one embodiment, each time unit in the first time unit set includes overlapping time-domain resources.

In one embodiment, lengths of time-domain resources included in each time unit in the first time unit set are the same.

In one embodiment, there are at least two time units in the first time unit set that occupy time-domain resources of different lengths.

In one embodiment, a position of the first time unit set in time domain depends on at least one of the first information block, the first RS resource set, and a data type included in the data collection.

In one embodiment, a position of the first time unit set in time domain includes: a start position of the first time unit set.

In one embodiment, a position of the first time unit set in time domain includes: an end position of the first time unit set.

In one embodiment, a position of the first time unit set in time domain includes: start and end moments of the first time unit set.

In one embodiment, a position of the first time unit set in time domain includes: a position of each time unit in the first time unit set in time domain.

In one embodiment, a position of the first time unit set in time domain includes: a start position of each time unit in the first time unit set.

In one embodiment, a position of the first time unit set in time domain includes: an end position of each time unit in the first time unit set.

In one embodiment, a position of the first time unit set in time domain includes: start and end moments of each time unit in the first time unit set.

In one embodiment, a position of the first time unit set in time domain includes: a position of each time unit in the first time unit set within the first time unit set.

In one embodiment, a position of the first time unit set in time domain includes: a position of each time unit in the first time unit set within the given period in the present application.

In one embodiment, a start position of the first time unit set in time domain is not earlier than the first signaling taking effect.

In one embodiment, a start position of the first time unit set in time domain is later than the first signaling taking effect.

In one embodiment, a position of the first time unit set in time domain depends on at least the first information block.

In one embodiment, a position of the first time unit set in time domain depends on at least time-domain resources occupied by a physical-layer channel transmitting the first information block.

In one embodiment, a position of the first time unit set in time domain depends on at least a physical-layer channel occupied by control signaling scheduling the first information block.

In one embodiment, a position of the first time unit set in time domain depends on at least time-domain resources occupied by control signaling scheduling the first information block.

In one embodiment, a position of the first time unit set in time domain depends on at least the first RS resource set.

In one embodiment, a position of the first time unit set in time domain depends on at least RS resources in the first RS resource set used for the data collection.

In one embodiment, a position of the first time unit set in time domain depends on at least transmission occasions of the first RS resource set.

In one embodiment, a position of the first time unit set in time domain depends on at least data type included in the data collection.

In one embodiment, data types included in the data collection include: physical layer information.

In one embodiment, data types included in the data collection include: higher layer information.

In one embodiment, data types included in the data collection include: AI inference information.

In one embodiment, data types included in the data collection include: information related to channel estimation.

In one embodiment, data types included in the data collection include: information related to power.

In one embodiment, data types included in the data collection include: information related to channel measurement.

In one embodiment, data types included in the data collection include: information related to CSI calculation.

In one embodiment, data types included in the data collection include: information related to beam management.

In one embodiment, data types included in the data collection include: information related to mobility management.

In one embodiment, data types included in the data collection include: information related to model monitoring.

In one embodiment, data types included in the data collection include: CSI.

In one embodiment, data types included in the data collection include: position-related information.

In one embodiment, data types included in the data collection include: decoding information.

In one embodiment, a position of the first time unit set in time domain depends on the first information block and the first RS resource set.

In one embodiment, a position of the first time unit set in time domain depends on the first information block and a data type included in the data collection.

In one embodiment, a position of the first time unit set in time domain depends on the first RS resource set and a data type included in the data collection.

In one embodiment, a position of the first time unit set in time domain depends on the first information block, the first RS resource set, and a data type included in the data collection.

### Embodiment 2

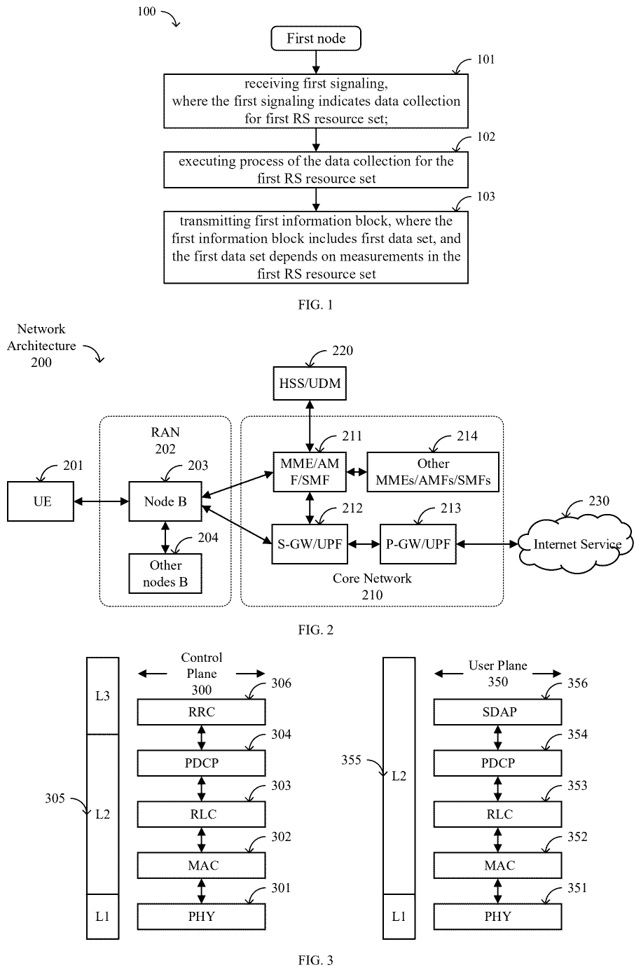

Embodiment 2 illustrates a schematic diagram of a network architecture according to one embodiment of the present application, as shown in FIG. 2.

FIG. 2 illustrates a network architecture 200. The network architecture 200 is a network architecture of LTE (Long-Term Evolution), LTE-A (Long-Term Evolution Advanced), 5G systems, 5G-Advanced, and future 6G systems. The network architectures of LTE, LTE-A, 5G systems, 5G-Advanced, and future 6G systems are referred to as EPS (Evolved Packet System). A 5G NR or LTE network architecture may be referred to as 5GS (5 G System)/EPS or some other suitable term; a 6G network architecture may be referred to as 6GS (6 G System)/EPS or some other suitable term.

The network architecture 200 may include one or more UEs 201, a RAN (Radio Access Network) 202, a core network 210, a HSS (Home Subscriber Server)/UDM (Unified Data Management) 220, and Internet services 230. The network architecture 200 may be interconnected with other access networks, but these entities/interfaces are not shown for simplicity.

As shown in FIG. 2, the network architecture 200 provides packet switching services. However, those skilled in the art will readily understand that the various concepts presented throughout this application can be extended to networks providing circuit switching services or other cellular networks. The RAN 202 includes a Node B 203 and other nodes 204. The Node B 203 provides user and control plane protocol termination towards the UE 201. The Node B 203 may be connected to other nodes 204 via an Xn interface (e.g., backhaul). The Node B 203 may also be referred to as an eNB (evolved Node B), gNB, base station, base transceiver station, radio base station, radio transceiver, transceiver function, BSS (Basic Service Set), ESS (Extended Service Set), TRP (Transmitter Receiver Point), or some other suitable term. The Node B 203 provides an access point to the core network 210 for the UE 201; the core network 210 is a 5GC (5G Core Network)/EPC (Evolved Packet Core), or the core network 210 is a 6GC (6 G Core Network). Examples of the UE 201 include a cellular phone, a smart phone, a Session Initiation Protocol (SIP) phone, a laptop computer, a Personal Digital Assistant (PDA), a satellite radio, a global positioning system, a multimedia device, a video device, a digital audio player (e.g., an MP3 player), a camera, a game console, a drone, an aircraft, a narrowband IoT device, a machine-type communication device, a land vehicle, an automobile, a wearable device, or any other similar functional device. Those skilled in the art may also refer to the UE 201 as a mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable term. The Node B 203 is connected to the core network 210 via an S1/NG interface. The core network 210 includes a MME (Mobility Management Entity)/AMF (Authentication Management Field)/SMF (Session Management Function) 211, other MMEs/AMFs/SMFs 214, a S-GW (Service Gateway)/UPF (User Plane Function) 212, and a P-GW (Packet Data Network Gateway)/UPF 213. The MME/AMF/SMF 211 is a control node that processes signaling between the UE and the core network 210. In general, the MME/AMF/SMF 211 provides bearer and connection management. All user IP (Internet Protocol) packets are transmitted through the S-GW/UPF 212, which itself is connected to the P-GW/UPF 213. The P-GW provides UE IP address assignment and other functions. The P-GW/UPF 213 is connected to the Internet services 230. The Internet services 230 include operator-corresponding Internet Protocol services, which may specifically include the Internet, an intranet, IMS (IP Multimedia Subsystem), and packet-switched streaming services.

In one embodiment, the first node in the present application includes the UE 201.

In one embodiment, the second node in the present application includes the Node B 203.

In one embodiment, the Node B 203 is a Macro Cell base station.

In one embodiment, the Node B 203 is a Micro Cell base station.

In one embodiment, the Node B 203 is a Pico Cell base station.

In one embodiment, the Node B 203 is a Femtocell.

In one embodiment, the Node B 203 is a base station that supports large time delay differences.

In one embodiment, the Node B 203 is an aerial platform device.

In one embodiment, the Node B 203 is a satellite device.

In one embodiment, the Node B 203 is a test device (e.g., a transceiver simulating partial functions of a base station, a signaling tester).

In one embodiment, the UE 201 includes a mobile phone.

In one embodiment, the UE 201 includes a vehicle such as an automobile.

In one embodiment, a wireless link from the UE 201 to the Node B 203 is an uplink, is the uplink being used to perform uplink transmission.

In one embodiment, a wireless link from the Node B 203 to the UE 201 is a downlink, the downlink being used to perform downlink transmission.

In one embodiment, the wireless link between the Node B 203 and the UE 201 includes a cellular network link.

In one embodiment, the Node B 203 and the UE 201 are connected via a Uu air interface.

In one embodiment, a transmitter of the first signaling in the present application includes the Node B 203.

In one embodiment, a receiver of the first signaling in the present application includes the UE 201.

In one embodiment, a transmitter of the second signaling in the present application includes the Node B 203.

In one embodiment, a receiver of the second signaling in the present application includes the UE 201.

In one embodiment, a transmitter of the first information block in the present application includes the UE 201.

In one embodiment, a receiver of the first information block in the present application includes the Node B 203.

In one embodiment, the Node B 203 supports deployment of Network-side (NW-side) AI/ML models.

In one embodiment, the UE 201 supports deployment of UE-side AI/ML models.

In one embodiment, the UE 201 supports UE-side data collection.

In one embodiment, the UE 201 supports 5G systems.

In one embodiment, the Node B 203 supports 5G systems.

In one embodiment, the UE 201 supports at least 6G systems.

In one embodiment, the Node B 203 supports at least 6G systems.

### Embodiment 3

Embodiment 3 illustrates a schematic diagram of a radio protocol architecture of a user plane and a control plane according to one embodiment of the present application, as shown in FIG. 3.

FIG. 3 illustrates a radio protocol architecture of a user plane 350 and a control plane 300 for a first communication node device (a UE or an RSU (Road Side Unit) in V2X (Vehicle to Everything), a vehicle-mounted device, or a vehicle-mounted communication module) and a second node device (a gNB, a UE, or an RSU in V2X, a vehicle-mounted device, or a vehicle-mounted communication module), or between two UEs, using three layers: Layer 1 (L1), Layer 2 (L2), and Layer 3 (L3). L1 is the lowest layer and implements various PHY (PHYsical layer) signal processing functions. L1 is referred to herein as PHY 301. L2 305 is above PHY 301 and is responsible for links between the first node device and the second node device, or between two UEs, via PHY 301. L2 305 includes a MAC (Medium Access Control) sublayer 302, an RLC (Radio Link Control) sublayer 303, and a PDCP (Packet Data Convergence Protocol) sublayer 304, which terminate at the second node device. The PDCP sublayer 304 provides multiplexing between different radio bearers and logical channels. The PDCP sublayer 304 also provides security by encrypting data packets and provides handover support for the first communication node device between second communication node devices. The RLC sublayer 303 provides segmentation and reassembly of upper layer data packets, retransmission of lost data packets, and reordering of data packets to compensate for out-of-order reception caused by HARQ (Hybrid Automatic Repeat reQuest). The MAC sublayer 302 provides multiplexing between logical and transport channels. The MAC sublayer 302 is also responsible for allocating various radio resources (e.g., resource blocks) in a cell among first communication node devices. The MAC sublayer 302 is also responsible for HARQ operations. An RRC (Radio Resource Control) sublayer 306 in L3 of the control plane 300 is responsible for acquiring radio resources (i.e., radio bearers) and configuring lower layers using RRC signaling between the second communication node device and the first communication node device. The radio protocol architecture of the user plane 350 includes L1 and L2. For the first communication node device and the second communication node device in the user plane 350, the radio protocol architecture is substantially the same as the corresponding layers and sublayers in the control plane 300 for the physical layer 351, the PDCP sublayer 354 in L2 355, the RLC sublayer 353 in L2 355, and the MAC sublayer 352 in L2 355, except that the PDCP sublayer 354 also provides header compression for upper layer data packets to reduce radio transmission overhead. The L2 355 in the user plane 350 further includes an SDAP (Service Data Adaptation Protocol) sublayer 356, which is responsible for mapping between QoS (Quality of Service) flows and DRBs (Data Radio Bearers) to support service diversity. Although not shown, the first communication node device may have several upper layers above L2 355, including a network layer (e.g., an IP (Internet Protocol) layer) terminating at the P-GW on the network side and an application layer terminating at the other end of the connection (e.g., a remote UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated in the RRC 306.

In one embodiment, the first signaling in the present application is generated in the MAC 302 or the MAC 352.

In one embodiment, the first information block in the present application is generated in the RRC 306.

In one embodiment, the second signaling in the present application is generated in the RRC 306.

In one embodiment, the second signaling in the present application is generated in the MAC 302 or the MAC 352.

In one embodiment, the second signaling in the present application is generated in the PHY 301 or the PHY 351.

In one embodiment, the higher layer in the present application refers to a layer above the physical layer.

In one embodiment, the higher layer in the present application includes the RRC layer.

In one embodiment, the higher layer signaling in the present application includes an RRC IE.

In one embodiment, the higher layer signaling in the present application includes an RRC message.

In one embodiment, the higher layer in the present application includes the MAC layer.

In one embodiment, the higher layer signaling in the present application includes a MAC CE.

### Embodiment 4

Embodiment 4 illustrates a schematic diagram of a first communication device and a second communication device according to one embodiment of the present application, as shown in FIG. 4. FIG. 4 is a block diagram of a first communication device 410 and a second communication device 450 communicating with each other in an access network.

The first communication device 410 includes a Controller/Processor 475, a Memory 476, a Receive Processor 470, a Transmit Processor 416, a Multi-Antenna Receive Processor 472, a Multi-Antenna Transmit Processor 471, a Transmitter/Receiver 418, and an Antenna 420.

The second communication device 450 includes a Controller/Processor 459, a Memory 460, a Data Source 467, a Transmit Processor 468, a Receive Processor 456, a Multi-Antenna Transmit Processor 457, a Multi-Antenna Receive Processor 458, a Transmitter/Receiver 454, and an Antenna 452.

In Transmission from the First Communication Device 410 to the Second Communication Device 450. At the first communication device 410, upper-layer data packets from the core network are provided to the Controller/Processor 475. The Controller/Processor 475 implements Layer 2 (L2) functionality. In the downlink (DL), the Controller/Processor 475 provides header compression, encryption, packet segmentation and reordering, multiplexing between logical and transport channels, and radio resource allocation to the second communication device 450 based on various priority metrics. The Controller/Processor 475 is also responsible for HARQ operations, retransmission of lost packets, and signaling to the second communication device 450. The Transmit Processor 416 and the Multi-Antenna Transmit Processor 471 implement various signal processing functions for Layer 1 (L1, i.e., the physical layer). The Transmit Processor 416 performs encoding and interleaving to facilitate Forward Error Correction (FEC) at the second communication device 450, and mapping of signal constellations based on various modulation schemes (e.g., Binary Phase Shift Keying (BPSK), Quadrature Phase Shift Keying (QPSK), M-ary Phase Shift Keying (M-PSK), M-ary Quadrature Amplitude Modulation (M-QAM)). The Multi-Antenna Transmit Processor 471 performs digital spatial precoding on the encoded and modulated symbols, including codebook-based precoding, non-codebook-based precoding, and beamforming processing, to generate one or more parallel streams. The Transmit Processor 416 then maps each parallel stream to subcarriers, multiplexes the modulated symbols with reference signals (e.g., pilots) in time domain and/or frequency domain, and subsequently uses an Inverse Fast Fourier Transform (IFFT) to generate a physical channel carrying a time-domain multi-carrier symbol stream. The Multi-Antenna Transmit Processor 471 then performs transmit analog precoding/beamforming operations on the time-domain multi-carrier symbol stream. Each Transmitter 418 converts the baseband multi-carrier symbol stream provided by the Multi-Antenna Transmit Processor 471 into a radio frequency (RF) stream, which is then provided to different Antennas 420.

In transmission from the first communication device 410 to the second communication device 450, at the second communication device 450, each Receiver 454 receives a signal via its corresponding Antenna 452. Each Receiver 454 recovers information modulated onto the RF carrier and converts the RF stream into a baseband multi-carrier symbol stream, which is provided to the Receive Processor 456. The Receive Processor 456 and the Multi-Antenna Receive Processor 458 implement various signal processing functions for L1. The Multi-Antenna Receive Processor 458 performs receive analog precoding/beamforming operations on the baseband multi-carrier symbol stream from the Receiver 454. The Receive Processor 456 uses a Fast Fourier Transform (FFT) to convert the baseband multi-carrier symbol stream after receive analog precoding/beamforming operations from time domain to frequency domain. In frequency domain, physical layer data signals and reference signals are demultiplexed by the Receive Processor 456, where the reference signals are used for channel estimation, and the data signals are subjected to multi-antenna detection in the Multi-Antenna Receive Processor 458 to recover any parallel streams destined for the second communication device 450. Symbols on each parallel stream are demodulated and recovered in the Receive Processor 456 to generate soft decisions. The Receive Processor 456 then decodes and deinterleaves the soft decisions to recover upper-layer data and control signals transmitted by the first communication device 410 on the physical channel. The upper-layer data and control signals are then provided to the Controller/Processor 459. The Controller/Processor 459 implements L2 functionality. The Controller/Processor 459 may be associated with a Memory 460 that stores program codes and data. The Memory 460 may be referred to as a computer-readable medium. In the DL, the Controller/Processor 459 provides demultiplexing between transport and logical channels, packet reassembly, decryption, header decompression, and control signal processing to recover upper-layer data packets from the core network. The upper-layer data packets are then provided to all protocol layers above L2. Various control signals may also be provided to L3 for L3 processing. The Controller/Processor 459 is also responsible for error detection using ACKnowledgement (ACK) and/or Negative ACKnowledgement (NACK) protocols to support HARQ operations.

In transmission from the Second Communication Device 450 to the First Communication Device 410. At the second communication device 450, a Data Source 467 is used to provide upper-layer data packets to the Controller/Processor 459. The Data Source 467 represents all protocol layers above L2. Similar to the transmit functionality at the first communication device 410 described in the DL, the Controller/Processor 459 implements header compression, encryption, packet segmentation and reordering, and multiplexing between logical and transport channels based on radio resource allocation from the first communication device 410, as well as L2 functionality for the user plane and control plane. The Controller/Processor 459 is also responsible for HARQ operations, retransmission of lost packets, and signaling to the first communication device 410. The Transmit Processor 468 performs modulation mapping and channel coding processing, and the Multi-Antenna Transmit Processor 457 performs digital multi-antenna spatial precoding, including codebook-based precoding and non-codebook-based precoding, and beamforming processing. The Transmit Processor 468 then modulates the generated parallel streams into a multi-carrier/single-carrier symbol stream, which is subjected to analog precoding/beamforming operations in the Multi-Antenna Transmit Processor 457 and then provided to different Antennas 452 via the Transmitter 454. Each Transmitter 454 first converts the baseband symbol stream provided by the Multi-Antenna Transmit Processor 457 into an RF symbol stream, which is then provided to the Antenna 452.

In transmission from the second communication device 450 to the first communication device 410, the functionality at the first communication device 410 is similar to the receive functionality at the second communication device 450 described in the transmission from the first communication device 410 to the second communication device 450. Each Receiver 418 receives an RF signal via its corresponding Antenna 420, converts the received RF signal into a baseband signal, and provides the baseband signal to the Multi-Antenna Receive Processor 472 and the Receive Processor 470. The Receive Processor 470 and the Multi-Antenna Receive Processor 472 jointly implement L1 functionality. The Controller/Processor 475 implements L2 functionality. The Controller/Processor 475 may be associated with a Memory 476 that stores program codes and data. The Memory 476 may be referred to as a computer-readable medium. The Controller/Processor 475 provides demultiplexing between transport and logical channels, packet reassembly, decryption, header decompression, and control signal processing to recover upper-layer data packets from the second communication device 450. Upper-layer data packets from the Controller/Processor 475 may be provided to the core network. The Controller/Processor 475 is also responsible for error detection using ACK and/or NACK protocols to support HARQ operations.

In one embodiment, the second communication device 450 includes: at least one processor and at least one memory, where the at least one memory includes computer program code; the at least one memory and the computer program code are configured to be used with the at least one processor. The second communication device 450 is configured to at least receive the first signaling in the present application, where the first signaling indicates data collection for the first RS resource set in the present application; execute a process of the data collection for the first RS resource set; transmit the first information block in the present application, where the first information block includes the first data set in the present application, and the first data set depends on measurements in the first RS resource set; executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and a data type included in the data collection.

In one embodiment, the second communication device 450 includes: a memory storing a computer-readable instruction program that, when executed by at least one processor, causes actions to be performed, the actions including: receiving the first signaling in the present application; executing a process of the data collection for the first RS resource set in the present application; transmitting the first information block in the present application.

In one embodiment, the first communication device 410 includes: at least one processor and at least one memory, where the at least one memory includes computer program code; the at least one memory and the computer program code are configured to be used with the at least one processor. The first communication device 410 is configured to at least transmit the first signaling in the present application, where the first signaling indicates data collection for the first RS resource set in the present application; receive the first information block in the present application, where the first information block includes the first data set in the present application, and the first data set depends on measurements performed by the second communication device 450 in the first RS resource set; the second communication device 450 executes a process of the data collection for the first RS resource set; executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and a data type included in the data collection.

In one embodiment, the first communication device 410 includes: a memory storing a computer-readable instruction program that, when executed by at least one processor, causes actions to be performed, the actions including: transmitting the first signaling in the present application; receiving the first information block in the present application.

In one embodiment, the first node in the present application includes the second communication device 450.

In one embodiment, the second node in the present application includes the first communication device 410.

In one embodiment, at least one of the Antenna 420, the Transmitter 418, the Transmit Processor 416, the Multi-Antenna Transmit Processor 471, the Controller/Processor 475, or the Memory 476 is used to transmit the first signaling in the present application; at least one of the Antenna 452, the Receiver 454, the Receive Processor 456, the Multi-Antenna Receive Processor 458, the Controller/Processor 459, the Memory 460, or the Data Source 467 is used to receive the first signaling in the present application.

In one embodiment, at least one of the Antenna 452, the Transmitter/Receiver 454, the Transmit Processor 468, the Receive Processor 456, the Multi-Antenna Transmit Processor 457, the Multi-Antenna Receive Processor 458, the Controller/Processor 459, the Memory 460, or the Data Source 467 is used to execute a process of data collection for the first RS resource set in the present application.

In one embodiment, at least one of the Antenna 452, the Receiver 454, the Receive Processor 456, the Multi-Antenna Receive Processor 458, the Controller/Processor 459, the Memory 460, or the Data Source 467 is used to execute process of data collection for the first RS resource set in the present application.

In one embodiment, at least one of the Antenna 452, the Transmitter/Receiver 454, the Transmit Processor 468, the Multi-Antenna Transmit Processor 457, the Controller/Processor 459, the Memory 460, or the Data Source 467 is used to transmit the first information block in the present application; at least one of the Antenna 420, the Receiver 418, the Receive Processor 470, the Multi-Antenna Receive Processor 472, the Controller/Processor 475, the Memory 476 is used to receive the first information block in the present application.

In one embodiment, at least one of the Antenna 420, the Transmitter 418, the Transmit Processor 416, the Multi-Antenna Transmit Processor 471, the Controller/Processor 475, or the Memory 476 is used to transmit the second signaling in the present application; at least one of the Antenna 452, the Receiver 454, the Receive Processor 456, the Multi-Antenna Receive Processor 458, the Controller/Processor 459, the Memory 460, or the Data Source 467 is used to receive the second signaling in the present application.

### Embodiment 5

Embodiment 5 illustrates a flowchart of transmission between a first node and a second node according to one embodiment of the present application, as shown in FIG. 5. In FIG. 5, a first node U1 and a second node N2 communicate via a wireless link; steps in block 51 are optional.

For the First Node U1, receives first signaling in step S510; executes a process of data collection for a first RS resource set in step S511; receives a second signaling in step S5110; transmits a first information block in step S512.

For the Second Node N2, transmits a first signaling in step S520; transmits a second signaling in step S5210; receives a first information block in step S521.

In Embodiment 5, the first signaling indicates data collection for a first RS resource set; the first information block includes a first data set, and the first data set depends on measurements performed by the first node U1 in the first RS resource set; executing the process of the data collection for the first RS resource set includes generating data in the first data set; the process of the data collection for the first RS resource set occupies processing resources in a first time unit set, and the first time unit set includes at least one time unit; a position of the first time unit set in time domain depends on at least one of the first information block, the first RS resource set, and data type included in the data collection.

In one embodiment, the first node U1 is the first node in the present application.

In one embodiment, the second node N2 is the second node in the present application.

In one embodiment, an air interface between the second node N2 and the first node U1 includes a wireless interface between a base station and a user equipment.

In one embodiment, an air interface between the second node N2 and the first node U1 includes a wireless interface between a relay node device and a user equipment.

In one embodiment, an air interface between the second node N2 and the first node U1 includes a wireless interface between user equipments.

In one embodiment, the second node N2 and the first node U1 communicate via a Uu interface.

In one embodiment, the second node N2 is a serving base station maintaining a serving cell of the first node U1.

In one embodiment, a transport channel occupied by the first signaling includes a DL-SCH (DownLink-Shared CHannel).

In one embodiment, a physical-layer channel occupied by the first signaling includes a PDSCH (Physical Downlink Shared CHannel).

In one embodiment, the first information block is beared by a SRBn (Signaling Radio Bearer n), where n is a positive integer not less than 4.

In one embodiment, the first information block is transmitted via NAS (Non-Access Stratum) signaling.

In one embodiment, a transport channel occupied by the first information block includes a UL-SCH (UpLink-Shared CHannel).

In one embodiment, a physical-layer channel occupied by the first information block includes a PUSCH (Physical Uplink Shared CHannel).

In one embodiment, the step S510 precedes the step S511.

In one embodiment, the step S511 precedes the step S512.

In one embodiment, the step S520 precedes the step S521.

In one embodiment, steps in block 51 of FIG. 5 exist, and the method for the first node in the present application includes: receiving a second signaling; wherein the second signaling schedules the first information block, or the second signaling instructs to deactivate the process of the data collection for the first RS resource set; a first moment is Y time-domain resource units after a last symbol of a physical-layer channel occupied by the second signaling; the Y depends on a data type included in the data collection, and Y is a positive integer greater than 1.

In one embodiment, the second signaling includes a dynamic signaling.

In one embodiment, the second signaling includes a control signaling.

In one embodiment, the second signaling is a MAC layer signaling.

In one embodiment, the second signaling is a MAC layer control signaling.

In one embodiment, the second signaling is a MAC CE signaling.

In one embodiment, the second signaling is a deactivation command.

In one embodiment, the second signaling instructs to deactivate the process of the data collection for the first RS resource set.

In one embodiment, the second signaling instructs to stop the process of the data collection for the first RS resource set.

In one embodiment, the second signaling instructs to end the process of the data collection for the first RS resource set.

In one embodiment, the second signaling instructs to deactivate the first RS resource set.

In one embodiment, the second signaling includes an SP CSI-RS/CSI-IM Resource Set Activation/Deactivation MAC CE.

In one embodiment, the second signaling includes an SP ZP CSI-RS Resource Set Activation/Deactivation MAC CE.

In one embodiment, a name of a MAC CE carrying the second signaling includes: Activation.

In one embodiment, a name of a MAC CE carrying the second signaling includes: Deactivation.

In one embodiment, a name of a MAC CE carrying the second signaling includes: Data.

In one embodiment, a name of a MAC CE carrying the second signaling includes: Collection.

In one embodiment, a name of a MAC CE carrying the second signaling includes: Collect.

In one embodiment, a name of a MAC CE carrying the second signaling includes: Resource.

In one embodiment, a name of a MAC CE carrying the second signaling includes: AI.

In one embodiment, a name of a MAC CE carrying the second signaling includes: ML.

In one embodiment, a name of a MAC CE carrying the second signaling includes: Training.

In one embodiment, the second signaling includes a Layer 1 (L1) signaling.

In one embodiment, the second signaling includes an L1 control signaling.

In one embodiment, the second signaling includes a physical layer signaling.

In one embodiment, the second signaling includes a physical layer control signaling.

In one embodiment, the second signaling includes DCI (Downlink Control Information).

In one embodiment, the second signaling includes one or more fields of DCI.

In one embodiment, the second signaling is a DCI.

In one embodiment, the second signaling includes a CRC (Cyclic Redundancy Check).

In one embodiment, the second signaling schedules the first information block.

In one embodiment, the second signaling is an UpLink grant (UL grant) signaling.

In one embodiment, the second signaling is a UL DCI.

In one embodiment, the second signaling is used to schedule PUSCH transmission.

In one embodiment, a DCI format adopted by the second signaling is either DCI format 0_1 or DCI format 0_2.

In one embodiment, a DCI format adopted by the second signaling is a DCI format other than DCI format 0_1 and DCI format 0_2.

In one embodiment, a CRC of the second signaling is scrambled by a C (Cell)-RNTI (Radio Network Temporary Identifier).

In one embodiment, a CRC of the second signaling is scrambled by SP-Data-RNTI.

In one embodiment, the second signaling indicates time-domain resources occupied by the first information block.

In one embodiment, the second signaling indicates frequency-domain resources occupied by the first information block.

In one embodiment, the second signaling indicates the first data set.

In one embodiment, the second signaling indicates the first RS resource set.

In one embodiment, the second signaling instructs the first node to transmit the first data set.

In one embodiment, the second signaling is transmitted on a downlink physical control channel (i.e., a downlink channel that can only be used to carry physical layer control information).

In one embodiment, a physical-layer channel occupied by the second signaling includes a PDCCH (Physical Downlink Control CHannel).

In one embodiment, the second signaling is transmitted on a downlink physical data channel (i.e., a downlink channel that can be used to carry physical layer data).

In one embodiment, a transport channel occupied by the second signaling includes a DL-SCH.

In one embodiment, a physical-layer channel occupied by the second signaling includes a PDSCH.

In one embodiment, the step S5110 follows the step S511; the step S5210 follows the step S520.

In one embodiment, steps in block 51 of FIG. 5 follow the step S511.

In one embodiment, steps in block 51 of FIG. 5 do not exist.

### Embodiment 6

Embodiment 6 illustrates a schematic diagram of a start moment of the first time unit set according to one embodiment of the present application, as shown in FIG. 6. In FIG. 6, the horizontal axis represents time; rectangles filled with solid gray, cross-diamond, . . . , cross-hatch represent time-domain resources occupied by RS resources in the first RS resource set; a start of the first time unit set is no earlier than a first one of symbols of an earliest RS resource in the first RS resource set after the first signaling takes effect; the first time unit set ends at a first moment.

In Embodiment 6, the first time unit set occupies continuous time-domain resources; the first moment depends on the first information block.

In one embodiment, the first time unit set occupies continuous time-domain resources.

In one embodiment, the first time unit set includes one or more time units.

In one embodiment, the first time unit set includes one or more subframes.

In one embodiment, the first time unit set includes one or more slots.

In one embodiment, the first time unit set includes multiple symbols.

In one embodiment, an amount of processing resources occupied by the process of the data collection for the first RS resource set remains unchanged in the first time unit set.

In one embodiment, an amount of processing resources occupied by the process of the data collection for the first RS resource set does not change over time in the first time unit set.

In one embodiment, a start of the first time unit set is no earlier than a first one of symbols of an earliest RS resource in the first RS resource set after the first signaling takes effect.

In one embodiment, the first time unit set starts at a first one of symbols of an earliest RS resource in the first RS resource set after the first signaling takes effect.

In one embodiment, the meaning of “after the first signaling takes effect” includes: after the first signaling is applied.

In one embodiment, the meaning of “after the first signaling takes effect” includes: after the first RS resource set is configured by the first signaling.

In one embodiment, the meaning of “after the first signaling takes effect” includes: after the data collection for the first RS resource set is configured by the first signaling.

In one embodiment, the meaning of “after the first signaling takes effect” includes: the first signaling is an RRC signaling, and after the data collection for the first RS resource set is configured.

In one embodiment, the meaning of “after the first signaling takes effect” includes: the first signaling is a MAC signaling, and after the first signaling is applied.

In one embodiment, an earliest RS resource in the first RS resource set refers to: an earliest transmission occasion in each transmission occasion in the first RS resource set.

In one embodiment, an earliest RS resource in the first RS resource set refers to: an earliest transmission occasion in each transmission occasion used for the data collection in the first RS resource set.

In one embodiment, an earliest RS resource in the first RS resource set refers to: an earliest transmission occasion in each transmission occasion of RS resources used for the data collection in the first RS resource set.

In one embodiment, an earliest RS resource in the first RS resource set refers to: an earliest RS resource in each transmission occasion of all RS resources used for the data collection in the first RS resource set.

In one embodiment, an earliest RS resource in the first RS resource set refers to: an earliest RS resource in each transmission occasion of the first RS resource set.

In one embodiment, an earliest RS resource in the first RS resource set refers to: in each transmission occasion of the first RS resource set, an earliest one of RS resources used for the data collection.

In one embodiment, an earliest RS resource in the first RS resource set refers to: an earliest one of RS resources of the first RS resource set in each transmission occasion.

In one embodiment, an earliest RS resource in the first RS resource set refers to: an earliest one of RS resources of the first RS resource set used for data collection in each transmission occasion

In one embodiment, the transmission occasion in the present application refers to: a time at which/ corresponding to/associated with/occupied for a transmission of the first RS (Reference Signal) resource set.

In one embodiment, the transmission occasion in the present application refers to: a time at which/ corresponding to/associated with/occupied for a transmission of the first RS resource set.

In one embodiment, the transmission occasion in the present application refers to: a time-domain position at which/corresponding to/associated with/occupied for a transmission of the first RS resource set.

In one embodiment, the transmission occasion in the present application refers to: a time-domain resource at which/corresponding to/associated with/occupied for a transmission of the first RS resource set.

In one embodiment, the transmission occasion in the present application refers to: a time at which/ corresponding to/associated with/occupied for a transmission of each RS resource in the first RS resource set.

In one embodiment, the transmission occasion in the present application refers to: a time at which/ corresponding to/associated with/occupied for a transmission of each RS resource in the first RS resource set.

In one embodiment, the transmission occasion in the present application refers to: a time-domain position at which/corresponding to/associated with/occupied for a transmission of each RS resource in the first RS resource set.

In one embodiment, the transmission occasion in the present application refers to: a time-domain resource at which/corresponding to/associated with/occupied for a transmission of each RS resource in the first RS resource set.

In one embodiment, the first moment depends on the first information block.

In one embodiment, the first moment depends on an end moment of a physical-layer channel occupied by the first information block.

In one embodiment, the first moment depends on a start moment of a physical-layer channel occupied by the first information block.

In one embodiment, the first moment depends on an end moment of a physical-layer channel occupied by a control signaling that schedules the first information block.

### Embodiment 7

Embodiment 7 illustrates a first schematic diagram of a first moment according to one embodiment of the present application, as shown in FIG. 7. In FIG. 7, the horizontal axis represents time; rectangles filled with upper diagonal hatching represent time-domain resources occupied by the first information block; the first time unit set ends at a first moment, where the first moment is a last one of symbols of a physical-layer channel occupied by the first information block.

In Embodiment 7, the first time unit set occupies continuous time-domain resources.

In one embodiment, the first time unit set occupies continuous time-domain resources.

In one embodiment, the first time unit set includes one or more time units.

In one embodiment, the first time unit set includes one or more subframes.

In one embodiment, the first time unit set includes one or more slots.

In one embodiment, the first time unit set includes multiple symbols.

In one embodiment, an amount of processing resources occupied by the process of the data collection for the first RS resource set remains unchanged in the first time unit set.

In one embodiment, an amount of processing resources occupied by the process of the data collection for the first RS resource set does not change over time in the first time unit set.

In one embodiment, the first moment is a last one of symbols of a physical-layer channel occupied by the first information block.

In one embodiment, the first moment is a last one of symbols of a physical-layer channel occupied by the first data set.

In one embodiment, the first moment is a last one of symbols of a physical layer data channel occupied by the first information block.

In one embodiment, the first moment is a last one of symbols of a physical layer data channel occupied by the first data set.

In one embodiment, the first moment is a last one of symbols of a PUSCH occupied by the first information block.

In one embodiment, the first moment is a last one of symbols of a PUSCH occupied by the first data set.

### Embodiment 8

Embodiment 8 illustrates a second schematic diagram of the first moment according to one embodiment of the present application, as shown in FIG. 8. In FIG. 8, the horizontal axis represents time; rectangles filled with lower diagonal hatching represent time-domain resources occupied by a second signaling; the first time unit set ends at a first moment, where the first moment is Y time-domain resource units after a last one of symbols of a physical-layer channel occupied by the second signaling.

In Embodiment 8, the first time unit set occupies continuous time-domain resources; the Y depends on a data type included in the data collection, Y being a positive integer greater than 1.

In one embodiment, the first moment is Y time-domain resource units after a last one of symbols of a physical-layer channel occupied by the second signaling.

In one embodiment, the first moment is Y time-domain resource units after a last one of symbols of a PDCCH occupied by the second signaling.

In one embodiment, one the time-domain resource unit in the present application is a subframe.

In one embodiment, one the time-domain resource unit in the present application is a slot.

In one embodiment, one the time-domain resource unit in the present application is a symbol.

In one embodiment, one the time-domain resource unit in the present application includes one or more slots.

In one embodiment, one the time-domain resource unit in the present application includes one or more subframes.

In one embodiment, one the time-domain resource unit in the present application includes one or more symbols.

In one embodiment, one the time-domain resource unit in the present application includes continuous time-domain resources.

In one embodiment, the Y time-domain resource units occupy continuous time-domain resources.

In one embodiment, the Y time-domain resource units include Y ms.

In one embodiment, the Y time-domain resource units include Y slots.

In one sub-embodiment of the embodiment, Y is equal to n_{CSI_ref}.

In one sub-embodiment of the embodiment, Y is not less than 4.

In one sub-embodiment of the embodiment, Y is not less than 5.

In one embodiment, the Y time-domain resource units include M symbols, where M is a positive integer greater than Y.

In one embodiment, the Y time-domain resource units depend on a capability of the first node.

In one embodiment, the Y time-domain resource units depend on the first node's capability to meet RS calculation delay requirements.

In one embodiment, the Y time-domain resource units depend on the first node's capability to decode PDCCH.

In one embodiment, the Y time-domain resource units depend on data type included in the data collection.

In one embodiment, the meaning that Y depends on data types included in the data collection include: a length of the Y time-domain resource units depends on a number of data types included in the data collection.

In one embodiment, the meaning that Y depends on data types included in the data collection include: a length of the Y time-domain resource units depends on whether a data type included in the data collection includes data of a given type.

In one embodiment, the meaning that Y depends on data types included in the data collection include: a length of the Y time-domain resource units depends on whether a data type included in the data collection belongs to data of a given type.

In one embodiment, the meaning that Y depends on data types included in the data collection include: a length of the Y time-domain resource units depends on whether a data type included in the data collection includes data output by inference.

In one embodiment, the meaning that Y depends on data types included in the data collection include: a length of the Y time-domain resource units depends on whether a data type included in the data collection includes data generated based on inference output results.

In one embodiment, the candidates for the data type include K1 candidate data types, the K1 candidate data types correspond to K1 candidate integers respectively, the K1 candidate integers are K1 non-negative integers respectively, a data type included in the data collection is a first candidate data type among the K1 candidate data types, the first candidate data type corresponds to a first candidate integer among the K1 candidate integers, and Y depends on the first candidate integer.

In one sub-embodiment of the embodiment, a value of Y is linearly related to the first candidate integer.

In one sub-embodiment of the embodiment, a value of Y is equal to the first candidate integer.

In one sub-embodiment of the embodiment, the K1 candidate data types include one or more of CSI, position-related information, decoding information, and mobility management-related information.

In one embodiment, the candidates for the data type include K2 candidate data type sets, the K2 candidate data type sets correspond to K2 candidate values respectively, the K2 candidate values are K2 non-negative integers respectively, a data type included in the data collection is a first candidate data type set among the K2 candidate data type sets, the first candidate data type set corresponds to a first candidate value among the K2 candidate values, and a value of Y depends on the first candidate value.

In one sub-embodiment of the embodiment, a value of Y is linearly related to the first candidate value.

In one sub-embodiment of the embodiment, a value of Y is equal to the first candidate value.

In one sub-embodiment of the embodiment, the K2 candidate data type sets include at least two of CSI, position-related information, decoding information, and mobility management-related information.

In one sub-embodiment of the embodiment, the K2 candidate data type sets include at least one of CSI, position-related information, decoding information, and mobility management-related information, and at least one data type other than the CSI, position-related information, decoding information, and mobility management-related information.

In one embodiment, the candidates for the data type include a first type and types other than the first type; a value of Y depends on whether the data type included in the data collection belongs to a first type; or, a value of Y depends on whether the data type included in the data collection includes the first type.

In one embodiment, the first type in the present application is physical layer information.

In one embodiment, the first type in the present application is a data type generated at the physical layer.

In one embodiment, the first type in the present application is higher-layer information.

In one embodiment, the first type in the present application is a data type generated at a higher layer.

In one embodiment, the first type in the present application is position-related information.

In one embodiment, the first type in the present application is decoding information.

In one embodiment, the first type in the present application is information related to channel estimation.

In one embodiment, the first type in the present application is information related to channel measurement.

In one embodiment, the first type in the present application is information related to CSI (Channel State Information) calculation.

In one embodiment, the first type in the present application is a data type used for CSI calculation.

In one embodiment, the first type in the present application is CSI.

In one embodiment, the first type in the present application is AI inference information.

In one embodiment, the first type in the present application is an inference-based data type.

In one embodiment, the first type in the present application is a data type generated based on inference output.

In one embodiment, the first type in the present application is information related to model monitoring.

In one embodiment, the first type in the present application is information related to power.

In one embodiment, the first type in the present application is a data type used for L1-RSRP calculation.

In one embodiment, the first type in the present application is mobility management-related information.

In one embodiment, the first type in the present application is a data type used for mobility management.

In one embodiment, the first type in the present application is information related to beam management.

In one embodiment, the first type in the present application is a data type used for beam management.

In one embodiment, Y depends on a number of data types included in the data collection.

In one embodiment, the number of the data types included in the data collection is indicated by datacollectionQuantity.

In one embodiment, the number of the data types included in the data collection is indicated by trainingdatacollectionQuantity.

In one embodiment, the number of the data types included in the data collection is indicated by trainingdataQuantity.

In one embodiment, the number of the data types included in the data collection is indicated by dataQuantity.

In one embodiment, the number of the data types included in the data collection is indicated by collectionQuantity.

In one embodiment, the number of the data types included in the data collection is indicated by collectedQuantity.

### Embodiment 9

Embodiment 9 illustrates a schematic diagram of a given period according to one embodiment of the present application, as shown in FIG. 9. In FIG. 9, the horizontal axis represents time; rectangles filled with solid gray, . . . , cross-diamond hatching represent time-domain resources occupied by RS resources in the first RS resource set; each time unit in the first time unit set starts at a first one of symbols of an earliest RS resource in each given period and ends at X time-domain resource units after a last one of symbols of a latest RS resource in each given period.

In Embodiment 9, time units included in the first time unit set are periodic, X being a positive integer greater than 1.

In one embodiment, an earliest RS resource in the each given period refers to: for a given period, an earliest transmission occasion in each transmission occasion in the first RS resource set.

In one embodiment, an earliest RS resource in each given period refers to: for a given period, an earliest transmission occasion in each transmission occasion used for the data collection in the first RS resource set.

In one embodiment, an earliest RS resource in each given period refers to: for a given period, an earliest transmission occasion in each transmission occasion of all RS resources used for the data collection in the first RS resource set.

In one embodiment, an earliest RS resource in each given period refers to: for a given period, an earliest one of RS resources of the first RS resource set in each transmission occasion.

In one embodiment, an earliest RS resource in each given period refers to: for a given period, an earliest one of RS resources of the first RS resource set used for data collection in each transmission occasion.

In one embodiment, an earliest RS resource in each given period refers to: for a given period, an earliest one of RS resources used for the data collection in each transmission occasion of the first RS resource set.

In one embodiment, a latest RS resource in each given period refers to: for a given period, a latest transmission occasion in each transmission occasion in the first RS resource set.

In one embodiment, a latest RS resource in each given period refers to: for a given period, a latest transmission occasion in each transmission occasion used for the data collection in the first RS resource set.

In one embodiment, a latest RS resource in each given period refers to: for a given period, a latest transmission occasion in each transmission occasion of all RS resources used for the data collection in the first RS resource set.

In one embodiment, a latest RS resource in each given period refers to: for a given period, a latest one of RS resources of the first RS resource set in each transmission occasion.

In one embodiment, a latest RS resource in each given period refers to: for a given period, a latest one of RS resources of the first RS resource set used for data collection in each transmission occasion.

In one embodiment, a latest RS resource in each given period refers to: for a given period, a latest one of RS resources used for the data collection in each transmission occasion of the first RS resource set.

In one embodiment, a length of the given period includes one or more subframes.

In one embodiment, a length of the given period includes one or more slots.

In one embodiment, a length of the given period includes one or more symbols.

In one embodiment, a length of the given period is configured by a higher-layer signaling.

In one embodiment, a length of the given period is configured by an RRC signaling.

In one embodiment, a length of the given period is configured by the first signaling.

In one embodiment, a signaling configuring the first RS resource set simultaneously configures the given period.

In one embodiment, the given period depends on a period of the first RS resource set, and a period of the first RS resource set is configured by higher-layer signaling.

In one sub-embodiment of the embodiment, a length of the given period is linearly related to a period of the first RS resource set.

In one sub-embodiment of the embodiment, a length of the given period is equal to a period of the first RS resource set.

In one sub-embodiment of the embodiment, a length of the given period is equal to a period of the first RS resource set multiplied by a first integer; the first integer is a positive integer greater than 1.

In an auxiliary embodiment of this sub-embodiment, the first integer is configured by a higher-layer signaling.

In one embodiment, a length of the given period depends on a data type included in the data collection.

In one embodiment, a length of the given period depends on a number of data types included in the data collection.

In one embodiment, a length of the given period depends on a number of data types included in the data collection.

In one embodiment, the meaning that a length of the given period depends on data types included in the data collection include: a length of the given period depending on data type included in the data collection depends on a number of data types included in the data collection.

In one embodiment, the meaning that a length of the given period depends on data types included in the data collection include: a length of the given period depends on whether the data type included in the data collection includes data of the first type in the present application.

In one embodiment, the meaning that a length of the given period depends on data types included in the data collection include: the length of the given period depends on whether the data type included in the data collection belongs to data of the first type in the present application.

In one embodiment, the candidates for the data type include M1 candidate data types, the M1 candidate data types correspond to M1 candidate periods respectively, M1 being a positive integer greater than 1, a data type included in the data collection is a first candidate data type among the M1 candidate data types, the first candidate data type corresponds to a first candidate period among the M1 candidate periods, and a length of the given period depends on the first candidate period.

In one sub-embodiment of the embodiment, a length of the given period is linearly related to the first candidate period.

In one sub-embodiment of the embodiment, a length of the given period is equal to the first candidate period.

In one sub-embodiment of the embodiment, the M1 candidate data types include at least one of CSI, position-related information, decoding information, and mobility management-related information.

In one embodiment, the candidates for the data type include M2 candidate data type sets, the M2 candidate data type sets correspond to M2 periods respectively, M2 being a positive integer greater than 1, a data type included in the data collection is a first candidate data type set among the M2 candidate data type sets, the first candidate data type set corresponds to a first period among the M2 candidate periods, and a length of the given period depends on the first period.

In one sub-embodiment of the embodiment, a length of the given period is linearly related to the first period.

In one sub-embodiment of the embodiment, a length of the given period is equal to the first period.

In one sub-embodiment of the embodiment, the M2 candidate data type sets include at least two of CSI, position-related information, decoding information, and mobility management-related information.

In one sub-embodiment of the embodiment, the M2 candidate data type sets include at least one of CSI, position-related information, decoding information, and mobility management-related information, and at least one of data types other than the CSI, position-related information, decoding information, and mobility management-related information.

In one embodiment, the candidates for the data type include the first type in the present application and a type other than the first type; the X depends on whether the data type included in the data collection belongs to the first type in the present application; or, a length of the given period depends on whether the data type included in the data collection includes the first type in the present application.

### Embodiment 10

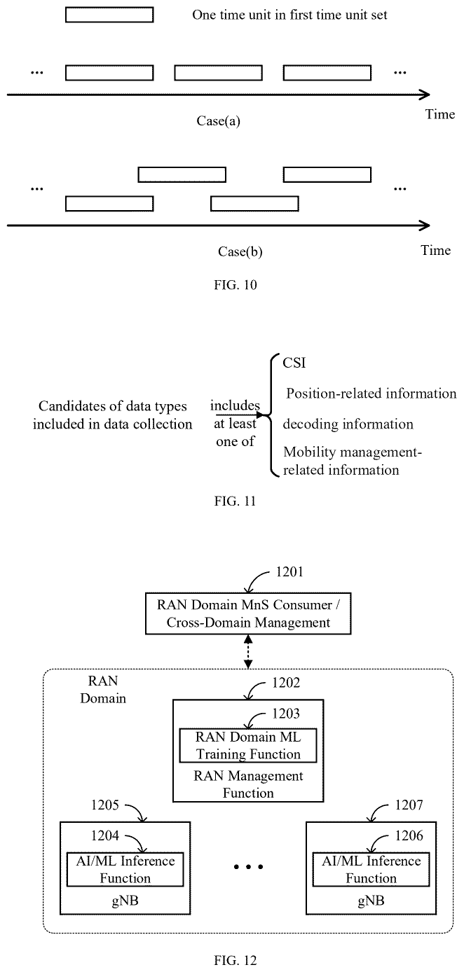

Embodiment 10 illustrates a schematic diagram of time-domain resources of a period occupied by a first time unit set according to one embodiment of the present application, as shown in FIG. 10. In FIG. 10, the horizontal axis represents time; rectangles without filling represent time-domain resources occupied by one time unit in the first time unit set; Case (a) indicates that time units in the first time unit set occupy orthogonal time-domain resources; Case (b) indicates that time units in the first time unit set occupy overlapping time-domain resources; it should be noted that FIG. 10 is merely an exemplary illustration and does not limit whether the first time unit set in Case (a) occupies discrete or continuous time-domain resources, nor does it limit a number of overlapping time units in Case (b).

In one embodiment, any time unit in the first time unit set includes one or more subframes.

In one embodiment, any time unit in the first time unit set includes one or more slots.

In one embodiment, any time unit in the first time unit set includes one or more symbols.

In one embodiment, any two time units in the first time unit set occupy orthogonal time-domain resources.

In one embodiment, two adjacent time units in the first time unit set are separated by at least one symbol.

In one embodiment, two adjacent time units in the first time unit set occupy continuous time-domain resources.

In one embodiment, there are at least two time units in the first time unit set that occupy overlapping time-domain resources.

In one embodiment, there are three time units in the first time unit set that occupy overlapping time-domain resources.

In one embodiment, the process of the data collection for the first RS resource set occupies a same amount of processing resources in any time unit of the first time unit set.

In one embodiment, the process of the data collection for the first RS resource set occupies a same amount of processing resources in time-domain resources included in the first time unit set.

In one embodiment, the process of the data collection for the first RS resource set occupies different amounts of processing resources in time-domain resources included in the first time unit set.

In one embodiment, for Case (b) of FIG. 10, the process of the data collection for the first RS resource set occupies N processing resources in any time unit of the first time unit set; the process of the data collection for the first RS resource set occupies 2N processing resources at an overlapping of two time units; where N is a positive integer.

In one embodiment, for Case (b) of FIG. 10, for time units included in the first time unit set, the process of the data collection for the first RS resource set occupies N processing resources in an orthogonal part of two time units, and 2N processing resources at an overlapping of two time units; where N is a positive integer.

In one embodiment, one the process of the data collection for the first RS resource set occupies one time unit included in the first time unit set.

In one embodiment, the first node starts the process of the data collection for the first RS resource set in each time unit included in the first time unit set.

In one sub-embodiment of the embodiment, for Case (b) of FIG. 10, the first node executes two parallel processes of the data collection for the first RS resource set at an overlapping of two time units.

### Embodiment 11

Embodiment 11 illustrates a schematic diagram of data types included in data collection according to one embodiment of the present application, as shown in FIG. 11. In FIG. 11, candidates for data types included in the data collection include at least one of CSI, position-related information, decoding information, and mobility management-related information.

In Embodiment 11, the CSI refers to: Channel State Information.

In one embodiment, candidates for data types included in the data collection include at least one of CSI, position-related information, decoding information, and mobility management-related information.

In one embodiment, the data type included in the data collection is CSI.

In one embodiment, the CSI includes compressed CSI.

In one embodiment, the CSI includes uncompressed CSI.

In one embodiment, the CSI includes a compressed CSI, uncompressed CSI pair.

In one embodiment, the CSI includes a CSI, predicted CSI pair.

In one embodiment, the CSI includes power information.

In one embodiment, the CSI includes RSRP.

In one embodiment, the CSI includes L1-RSRP.

In one embodiment, the CSI includes higher-layer RSRP.

In one embodiment, the CSI includes SINR.

In one embodiment, the CSI includes L1-SINR.

In one embodiment, the CSI includes SNR (Signal to Noise Ratio).

In one embodiment, the CSI includes RSSI.

In one embodiment, the CSI includes CLI (Cross Link Interference)-RSSI.

In one embodiment, the CSI includes CQI (Channel Quality Indicator).

In one embodiment, the CSI includes a wideband CQI.

In one embodiment, the CSI includes at least one subband CQI.

In one embodiment, the CSI includes PMI (Precoding Matrix Indicator).

In one embodiment, the CSI includes a wideband PMI.

In one embodiment, the CSI includes at least one subband PMI.

In one embodiment, the CSI includes RI (Rank Indicator).

In one embodiment, the CSI includes LI (Layer Indicator).

In one embodiment, the CSI includes CRI (CSI-RS Resource Indicator).

In one embodiment, the CSI includes SSBRI (SSB Resource Indicator).

In one embodiment, the CSI includes at least one of CQI, PMI, CRI, RI, LI, SSBRI, L1-RSRP, L1-SINR, capability index, or capability set index.

In one embodiment, the data type included in the data collection is position-related information of the first node.

In one embodiment, position-related information of the first node includes at least one of longitude and latitude where the first node is located.

In one embodiment, position-related information of the first node includes at least one of longitude, latitude, and altitude where the first node is located.

In one embodiment, position-related information of the first node includes a longitude-latitude region corresponding to the longitude and latitude where the first node is located.

In one embodiment, position-related information of the first node includes a spatial region corresponding to the longitude, latitude, and altitude where the first node is located.

In one embodiment, position-related information of the first node is related to a region identifier corresponding to the first node.

In one sub-embodiment of the embodiment, the region identifier is a cell Id.

In one sub-embodiment of the embodiment, the region identifier is a non-negative integer.

In one sub-embodiment of the embodiment, the region identifier corresponds to a pair of integers, which are used to indicate the horizontal position and vertical position of the first node relative to a reference point, respectively.

In one sub-embodiment of the embodiment, the region identifier corresponds to a pair of integers, which are used to indicate the longitude position and latitude position of the first node relative to a reference point, respectively.

In one sub-embodiment of the embodiment, the region identifier corresponds to a pair of integers, which are used to indicate the lateral position and longitudinal position of the first node relative to a reference point, respectively.

In one sub-embodiment of the embodiment, the region identifier corresponds to three integers, which are used to indicate the horizontal position, vertical position, and altitude of the first node relative to a reference point, respectively.

In one sub-embodiment of the embodiment, the region identifier corresponds to three integers, which are used to indicate the lateral position, longitudinal position, and altitude of the first node relative to a reference point, respectively.

In one embodiment, position-related information of the first node includes the distance of the first node relative to a reference point.

In one embodiment, position-related information of the first node includes a position of the first node relative to a reference point.

In one embodiment, position-related information of the first node includes the AoD (Angle of Departure) corresponding to the first node when receiving RS in the first RS resource set.

In one embodiment, the one reference point in Embodiment 11 is fixed.

In one embodiment, the one reference point in Embodiment 11 is a serving base station of the first node.

In one embodiment, the one reference point in Embodiment 11 is the second node in the present application.

In one embodiment, the one reference point in Embodiment 11 is a relay node.

In one embodiment, the one reference point in Embodiment 11 is a RIS (Reconfigurable Intelligent Surface).

In one embodiment, the data type included in the data collection is decoding information.

In one embodiment, the decoding information includes a decoder of the first node.

In one embodiment, the decoding information includes whether the first node adopts AI decoding.

In one embodiment, the decoding information includes whether the first node successfully decodes.

In one embodiment, the decoding information includes a type of a decoder adopted by the first node.

In one embodiment, the decoding information includes an identifier of a decoder adopted by the first node.

In one embodiment, the decoding information includes whether the first node decodes based on AI.

In one embodiment, the decoding information includes BER (Bit Error Rate).

In one embodiment, the decoding information includes BLER (BLock Error Rate).

In one embodiment, the decoding information includes HARQ.

In one embodiment, the decoding information includes HARQ-ACK.

In one embodiment, the decoding information includes HARQ-NACK.

In one embodiment, the decoding information includes a channel matrix.

In one embodiment, the data type included in the data collection is mobility management-related information.

In one embodiment, the mobility management-related information includes inter-system mobility.

In one embodiment, the mobility management-related information includes inter-RAT mobility management.

In one embodiment, the mobility management-related information includes inter-cell mobility management.

In one embodiment, the mobility management-related information includes a cell reselection result.

In one embodiment, the mobility management-related information includes a target cell identifier.

In one embodiment, the mobility management-related information includes a candidate cell identifier.

In one embodiment, the mobility management-related information includes an LTM (L1/L2 Triggered Mobility) candidate cell identifier.

In one embodiment, the mobility management-related information includes beam-level mobility management.

In one embodiment, the mobility management-related information includes a beam indication.

In one embodiment, the mobility management-related information includes a measurement report.

In one embodiment, the mobility management-related information includes neighbor cell power information.

In one embodiment, the mobility management-related information includes neighbor cell RSRP.

In one embodiment, the mobility management-related information includes neighbor cell SINR.

In one embodiment, the mobility management-related information includes neighbor cell RSRQ.

In one embodiment, the mobility management-related information includes HOF (HandOver Failure).

In one embodiment, the mobility management-related information includes RLF (Radio Link Failure).

### Embodiment 12

Embodiment 12 illustrates a schematic diagram of RAN domain AI/ML function deployment according to one embodiment of the present application, as shown in FIG. 12. In FIG. 12, a gNB may be replaced with a network device such as an eNB or a 6G base station.

In Embodiment 12, the management of the ML inference functions of multiple base stations is performed by a RAN Domain Management Function 1202, i.e., data interaction is conducted with RAN domain MnS (Management Service) consumers/cross-domain management 1201 (as indicated by the dashed arrows in FIG. 12). A RAN Domain ML Training Function 1203 is located in the RAN Domain Management Function 1202; while ML inference functions are located in base stations, i.e., an AI/ML Inference Function 1204 is located in a gNB 1205, an AI/ML Inference Function 1206 is located in a gNB 1207, and so on.

AI/ML-related functions include an ML training function (also referred to as AI training or AI/ML training), an ML testing function, an ML inference function (also referred to as AI inference or AI/ML inference), and the like. The ML training function, ML testing function, and ML inference function may be deployed independently or co-located. The deployment of AI/ML-related functions may be implemented through software (e.g., downloading and/or running executable files) or through a combination of software and hardware (e.g., accelerating specific computing units via hardware to improve computing speed or save power consumption).

For the ML training function, it may be deployed in a cross-domain management system or a domain-specific management system; the domain-specific management system is used to manage the RAN domain or Core Network (CN) domain. For example, an ML training function for MDA (Management Data Analytics) may be deployed in an MDAF (Management Data Analytic Function); an ML training function for network data analytics may be deployed in an NWDAF (NetWork Data Analytics Function), i.e., the ML training function is an MTLF (Model Training Logical Function).

For the ML inference function, it may also be deployed in a cross-domain management system or a domain-specific management system; for example, the ML inference function is an MDAF, or the ML inference function is an AnLF (Analytics Logical Function) located in the NWDAF.

Similarly, the ML testing function may also be deployed in a cross-domain management system or a domain-specific management system.

Optionally, the management of the ML inference function may also be performed independently by each base station, i.e., each base station may independently conduct data interaction with the RAN domain MnS consumers/cross-domain management 1201.

It should be noted that Embodiment 12 is merely a non-limiting implementation manner; optionally, the RAN domain ML training function may also be deployed in a base station; or alternatively, some base stations deploy both the ML inference function and the RAN domain ML training function, while other base stations only deploy the ML inference function.

In one embodiment, a gNB (or base station) in Embodiment 12 is the second node in the present application.

In one embodiment, the first data set in the present application is used for the ML Training Function 1203.

In one embodiment, the first data set in the present application is reserved for ML testing.

### Embodiment 13

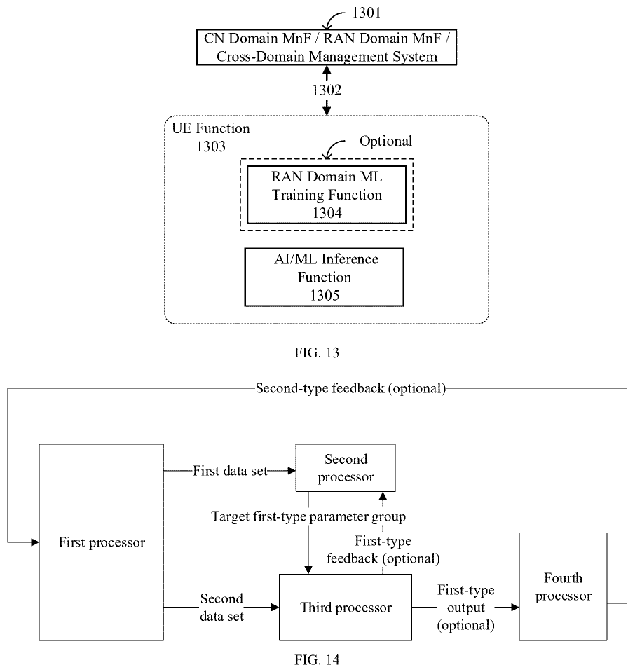

Embodiment 13 illustrates a schematic diagram of AI/ML function deployment of a UE according to one embodiment of the present application, as shown in FIG. 13. In FIG. 13, a RAN Domain ML Training Function 1304 is optional.

A UE Function 1303 is deployed in the first node in the present application, and the UE Function 1303 includes an AI/ML Inference Function 1305; the AI/ML Inference Function 1305 performs inference using an ML model (also referred to as an AI model); an ML model usually undergoes training before being used for AI/ML inference.

In one embodiment, the UE Function 1303 includes the RAN Domain ML Training Function 1304, and the RAN Domain ML Training Function 1304 runs training data through the ML model to derive related loss, and adjusts parameters of the ML model based on the calculated loss; the ML training includes at least one of ML initial training, ML re-training, and reinforcement learning.

The above embodiment reduces the complexity of the base station or saves air interface resources caused by reporting training data; however, the above embodiment imposes higher requirements on the processing capability of the UE side.

Optionally, the UE Function 1303 further includes a CN domain ML training function (not shown in FIG. 13).

Optionally, the UE Function 1303 further includes an AI/ML deployment function (not shown in FIG. 13) for loading the ML model and data.

In one embodiment, the first node indicates whether it supports the ML training function (RAN domain or CN domain) through capability reporting, and the capability reporting is an RRC signaling or a Non-Access Stratum (NAS) signaling.

In one embodiment, the ML model and related metadata are loaded by the first node from a network device or a remote server.

Optionally, the UE Function 1303 is an MnS producer that provides data to a CN domain MnF (Management Function), a RAN domain MnF, and/or a cross-domain management system 1301 for management or analysis (as indicated by the double arrow 1302).

Optionally, the UE Function 1303 is an MnS consumer that loads data from the CN domain MnF, the RAN domain MnF, and/or the cross-domain management system 1301 for AI/ML-related management, such as management data requests, ML model activation, and/or ML training (as indicated by the double arrow 1302).

In one embodiment, the data collection in the present application is used for the RAN Domain ML Training Function 1304.

In one embodiment, the data collection in the present application generates the related metadata.

In one embodiment, the UE Function 1303 is an MnS producer, and the first node performs the data collection in the present application to generate data.

In one embodiment, the first node is an MnS producer, and the first node provides data to the second node in the present application by transmitting the first information block in the present application.

In one embodiment, the ML model is based on NN (Neural Networks).

In one embodiment, the ML model is based on ANN (Artificial Neural Networks).

In one embodiment, the ML model is based on CNN (Convolutional Neural Networks).

In one embodiment, the ML model is based on a LLM (Large Language Model) architecture.

In one embodiment, the ML model is based on a Transformer architecture.

In one embodiment, the ML model is based on LSTM (Long Short-Term Memory).

In one embodiment, the ML model is based on MLP (MultiLayer Perceptron).

In one embodiment, the ML model is based on GAN (Generative Adversarial Nets).

In one embodiment, the ML model is based on a lightweight neural network.

In one sub-embodiment of the embodiment, the lightweight neural network includes one or more of MobileNet, ShuffleNet, and SqueezeNet.

### Embodiment 14

Embodiment 14 illustrates a schematic diagram of an artificial intelligence or machine learning-based processing system according to one embodiment of the present application, as shown in FIG. 14. In FIG. 14, the artificial intelligence or machine learning-based processing system includes a first processor, a second processor, a third processor, and a fourth processor.

In Embodiment 14, the first processor transmits a first data set to the second processor and a second data set to the third processor; the second processor generates a target first-type parameter set according to the first data set, and the second processor transmits the generated target first-type parameter set to the third processor; the third processor processes the second data set using the target first-type parameter set to obtain a first-type output; optionally, the third processor transmits the first-type output to the fourth processor. In FIG. 14, a first-type feedback and a second-type feedback are optional; the second processor includes an ML training function; the third processor includes an ML inference function.

In one embodiment, the fourth processor includes an ML testing function.

In one embodiment, the fourth processor includes performance monitoring/evaluation of the ML model.

In one embodiment, the third processor transmits the first-type feedback to the second processor; the first-type feedback is used to trigger recalculation or update of the target first-type parameter set, i.e., trigger ML initial training or ML re-training.

In one embodiment, the fourth processor transmits the second-type feedback to the first processor; the second-type feedback is used to generate the first data set or the second data set, or the second-type feedback is used to trigger a transmission of the first data set or a transmission of the second data set.

In one embodiment, the first processor generates the first data set and the second data set according to measurements of reference signals.

In one embodiment, the third processor belongs to the first node, and the fourth processor belongs to the second node.

In one embodiment, the third processor belongs to the first node.

In one embodiment, the first data set includes training data.

In one embodiment, the first data set is the first data set in the present application.

In one embodiment, the first data set includes a data set generated by the first node performing data collection.

In one embodiment, a data set generated by the first node performing data collection includes the first data set.

In one embodiment, the second processor is used to train the ML model, and the trained model is described by the target first-type parameter set.

In one embodiment, the second processor belongs to the first node; the above method avoids transmitting the first data set to the second node.

In one embodiment, the second processor belongs to the second node in the present application; the above method supports joint training and optimizes system performance.

In one embodiment, the second processor belongs to the core network; the above method supports network-wide joint training and further optimizes system performance.

In one embodiment, the second data set includes inference data.

In one embodiment, the third processor constructs a model according to the target first-type parameter set, and then inputs the second data set into the constructed model to obtain the first-type output.

In one embodiment, the third processor generates a recovery data set according to the first-type output, and an error between the recovery data set and the second data set is used to generate the first-type feedback.

In one embodiment, the first-type feedback is used to reflect the performance of the trained model; when the performance of the trained model fails to meet requirements, the second processor recalculates the target first-type parameter set.

In one embodiment, the performance of the trained model is considered to fail to meet requirements when the error is too large or no update has been performed for a too long time.

In one embodiment, the target first-type parameter set includes one or more of: a kernel, a pool core, a pooling function, an activation function, parameters of the pooling function, or parameters of the activation function.

In one embodiment, the target first-type parameter set includes one or more of: a convolutional kernel size, a number of convolutional layers, a convolutional stride, a pool core size, a pool core stride, a pooling function, an activation function, or a number of feature maps.

### Embodiment 15

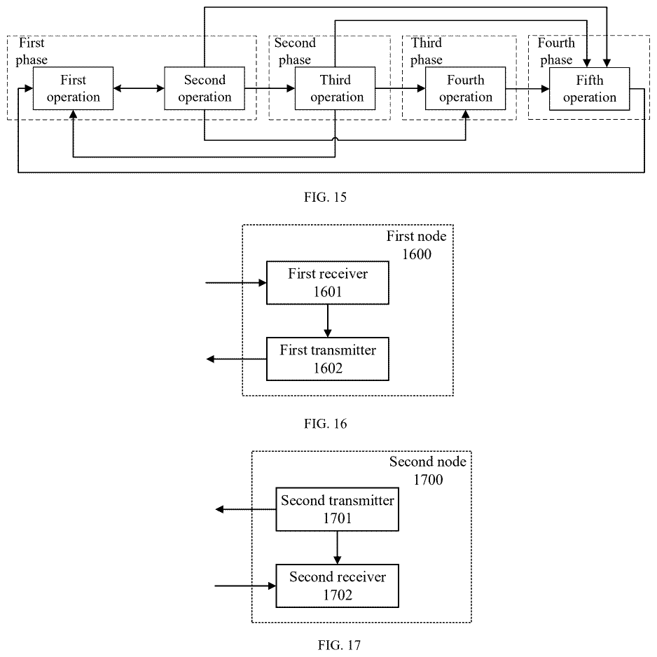

Embodiment 15 illustrates a schematic diagram based on artificial intelligence or machine learning according to one embodiment of the present application, as shown in FIG. 15. In FIG. 15, the first operation and second operation belong to a first phase; the third operation belongs to a second phase; the fourth operation belongs to a third phase; the fifth operation belongs to a fourth phase; lines with arrows indicate the sequence of the process.

In one embodiment: the first operation includes AI/ML training; the second operation includes AI/ML testing; the third operation includes AI/ML emulation; the fourth operation includes AI/ML entity loading; the fifth operation includes AI/ML inference.

In one embodiment: the first phase includes a training phase; the second phase includes an emulation phase; the third phase includes a deployment phase; the fourth phase includes an inference phase.

In one embodiment, the first phase includes AI/ML model training.

In one embodiment, the first phase includes AI/ML model training and AI/ML testing.

In one embodiment, the AI/ML model training includes initial training and re-training of one or a group of AI/ML entities.

In one embodiment, the AI/ML model training depends on training data.

In one embodiment, the AI/ML model training depends on the first data collection in the present application.

In one embodiment, the AI/ML model training includes AI/ML entity validation.

In one embodiment, the AI/ML entity validation is used to evaluate the performance of the AI/ML entity.

In one embodiment, the AI/ML entity validation depends on validation data.

In one embodiment, if the result of the AI/ML entity validation fails to meet expectations, the AI/ML model will be re-trained.

In one embodiment, the AI/ML testing includes testing the validated AI/ML entity to evaluate the performance of the trained AI/ML model.

In one embodiment, if the result of the AI/ML testing meets expectations, the AI/ML entity proceeds to the next phase; otherwise, the AI/ML model will be re-trained.

In one embodiment, the AI/ML testing depends on testing data.

In one embodiment, the second phase includes AI/ML emulation, which performs inference of the AI/ML entity in an emulation environment.

In one embodiment, the AI/ML emulation is used to estimate the inference performance of the AI/ML entity in the emulation environment before using the AI/ML entity.

In one embodiment, the second phase is optional.

In one embodiment, the third phase includes AI/ML entity loading, which is used to obtain the trained AI/ML entity to achieve the desired AI/ML inference function.

In one embodiment, the third phase is optional.

In one embodiment, when the training function and the inference function are co-located, the third phase is no longer required.

In one embodiment, the fourth phase includes AI/ML inference.

### Embodiment 16

Embodiment 16 illustrates a structural block diagram of a processor for a first node according to one embodiment of the present application, as shown in FIG. 16. In FIG. 16, the processor 1600 in the first node includes a first receiver 1601 and a first transmitter 1602.

In Embodiment 16, the first receiver 1601 receives first signaling, where the first signaling indicates data collection for a first RS resource set; the first receiver 1601 executes a process of the data collection for the first RS resource set; the first transmitter 1602 transmits a first information block, where the first information block includes a first data set, and the first data set depends on measurements in the first RS resource set.

In Embodiment 16, executing the process of the data collection for the first RS resource set includes generating data in the first data set; the process of the data collection for the first RS resource set occupies processing resources in a first time unit set, the first time unit set including at least one time unit; a position of the first time unit set in time domain depends on at least one of the first information block, the first RS resource set, and a data type included in the data collection.

In one embodiment, the first time unit set occupies continuous time-domain resources; a start of the first time unit set is no earlier than a first one of symbols of an earliest RS resource in the first RS resource set after the first signaling takes effect; the first time unit set ends at a first moment, which depends on the first information block.

In one embodiment, the first moment is a last one of symbols of a physical-layer channel occupied by the first information block.

In one embodiment, the first receiver 1601 receives a second signaling; the second signaling schedules the first information block, or the second signaling instructs to deactivate the process of the data collection for the first RS resource set; the first moment is Y time-domain resource units after a last one of symbols of a physical-layer channel occupied by the second signaling; the Y depends on a data type included in the data collection, Y being a positive integer greater than 1.

In one embodiment, time units included in the first time unit set are periodic; each time unit in the first time unit set starts at a first one of symbols of an earliest RS resource in each given period, and ends at X time-domain resource units after a last one of symbols of a latest RS resource in each given period; the X is a positive integer greater than 1.

In one embodiment, the X depends on a data type included in the data collection.

In one embodiment, a length of the given period is configured by a higher-layer signaling, or a length of the given period depends on a data type included in the data collection.

In one embodiment, candidates for data types included in the data collection include at least one of CSI, position-related information, decoding information, and mobility management-related information.

In one embodiment, after the first signaling takes effect, the first node executes the process of the data collection for the first RS resource set.

In one embodiment, in response to the first signaling being applied, the first node executes the process of the data collection for the first RS resource set.

In one embodiment, the process of the data collection for the first RS resource set occupies a same amount of processing resources in any time unit of the first time unit set.

Typically, the processing resources occupied by the process of the data collection only include computing resources.

Typically, the processing resources occupied by the process of the data collection include computing resources and storage resources.

In one embodiment, a position of the first time unit set in time domain depends on at least time-domain resources occupied by a physical-layer channel transmitting the first information block.

In one embodiment, a position of the first time unit set in time domain depends on at least a physical-layer channel occupied by the control signaling scheduling the first information block.

In one embodiment, a position of the first time unit set in time domain depends on at least RS resources used for the data collection in the first RS resource set.

In one embodiment, the first moment depends on a start moment of a physical-layer channel occupied by the first information block.

In one embodiment, the first moment depends on an end moment of a physical-layer channel occupied by a control signaling scheduling the first information block.

In one embodiment, the Y depends on a number of data types included in the data collection.

In one embodiment, the first data set is used for model training.

In one embodiment, the first data set is used for model validation.

In one embodiment, the first data set is used for model testing.

In one embodiment, the first signaling instructs to activate/start/run the process of the data collection for the first RS resource set.

In one embodiment, the second signaling instructs to deactivate/stop/end the process of the data collection for the first RS resource set.

In one embodiment, the first node 1600 is a user equipment (UE).

In one embodiment, the first node 1600 is a terminal.

In one embodiment, the first node 1600 is a relay node device.

In one embodiment, the first receiver 1601 includes at least one of the Antenna 452, the Receiver 454, the Receive Processor 456, the Multi-Antenna Receive Processor 458, the Controller/Processor 459, the Memory 460, or the Data Source 467 in Embodiment 4.

In one embodiment, the first transmitter 1602 includes at least one of the Antenna 452, the Transmitter 454, the Transmit Processor 468, the Multi-Antenna Transmit Processor 457, the Controller/Processor 459, the Memory 460, or the Data Source 467 in Embodiment 4.

### Embodiment 17

Embodiment 17 illustrates a structural block diagram of a processor for a second node according to one embodiment of the present application, as shown in FIG. 17. In FIG. 17, the processor 1700 in the second node includes a second transmitter 1701 and a second receiver 1702.

In Embodiment 17, The second transmitter 1701 transmits first signaling, where the first signaling indicates data collection for a first RS resource set; the second receiver 1702 receives a first information block, where the first information block includes a first data set, and the first data set depends on measurements performed by a receiver of the first signaling in the first RS resource set.

In Embodiment 17, a receiver of the first signaling executes a process of the data collection for the first RS resource set; executing the process of the data collection for the first RS resource set includes generating data in the first data set; the process of the data collection for the first RS resource set occupies processing resources in a first time unit set, and the first time unit includes at least one time unit; a position of the first time unit set in time domain depends on at least one of the first information block, the first RS resource set, and a data type included in the data collection.

In one embodiment, the first time unit set occupies continuous time-domain resources; a start of the first time unit set is no earlier than a first one of symbols of an earliest RS resource in the first RS resource set after the first signaling takes effect; the first time unit set ends at a first moment, and the first moment depends on the first information block.

In one embodiment, the first moment is a last one of symbols of a physical-layer channel occupied by the first information block.

In one embodiment, the second transmitter 1701 transmits a second signaling; the second signaling schedules the first information block, or the second signaling instructs to deactivate the process of the data collection for the first RS resource set; the first moment is Y time-domain resource units after a last one of symbols of a physical-layer channel occupied by the second signaling; the Y depends on a data type included in the data collection, Y being a positive integer greater than 1.

In one embodiment, time units included in the first time unit set are periodic; each time unit in the first time unit set starts at a first one of symbols of an earliest RS resource in each given period, and ends at X time-domain resource units after a last one of symbols of a latest RS resource in each given period; the X is a positive integer greater than 1.

In one embodiment, the X depends on a data type included in the data collection.

In one embodiment, a length of the given period is configured by a higher-layer signaling, or a length of the given period depends on a data type included in the data collection.

In one embodiment, candidates for data types included in the data collection include at least one of CSI, position-related information, decoding information, and mobility management-related information.

In one embodiment, after the first signaling takes effect, the first node executes the process of the data collection for the first RS resource set.

In one embodiment, in response to the first signaling being applied, the first node executes the process of the data collection for the first RS resource set.

In one embodiment, executing the process of the data collection for the first RS resource set occupies a same amount of processing resources in any time unit in the first time unit set.

Typically, the processing resources occupied by the process of the data collection only include computing resources.

Typically, the processing resources occupied by the process of the data collection include computing resources and storage resources.

In one embodiment, a position of the first time unit set in time domain depends on at least time-domain resources occupied by a physical-layer channel transmitting the first information block.

In one embodiment, a position of the first time unit set in time domain depends on at least a physical-layer channel occupied by a control signaling scheduling the first information block.

In one embodiment, a position of the first time unit set in time domain depends on at least RS resources used for the data collection in the first RS resource set.

In one embodiment, the first moment depends on a start moment of a physical-layer channel occupied by the first information block.

In one embodiment, the first moment depends on an end moment of a physical-layer channel occupied by a control signaling scheduling the first information block.

In one embodiment, the Y depends on a number of data types included in the data collection.

In one embodiment, the first data set is used for model training.

In one embodiment, the first data set is used for model validation.

In one embodiment, the first data set is used for model testing.

In one embodiment, the first signaling instructs to activate/start/run the process of the data collection for the first RS resource set.

In one embodiment, the second signaling instructs to deactivate/stop/end the process of the data collection for the first RS resource set.

In one embodiment, the second node 1700 is a base station.

In one embodiment, the second node 1700 is a user equipment (UE).

In one embodiment, the second node 1700 is a TRP (Transmitter Receiver Point).

In one embodiment, the second transmitter 1701 includes at least one of the Antenna 420, the Transmitter 418, the Transmit Processor 416, the Multi-Antenna Transmit Processor 471, the Controller/Processor 475, or the Memory 476 in Embodiment 4.

In one embodiment, the second receiver 1702 includes at least one of the Antenna 420, the Receiver 418, the Receive Processor 470, the Multi-Antenna Receive Processor 472, the Controller/Processor 475, or the Memory 476 in Embodiment 4.

Those of ordinary skill in the art will understand that all or part of the steps in the above methods may be completed by instructing relevant hardware through a program, and the program may be stored in a computer-readable storage medium such as a read-only memory (ROM), a hard disk, or an optical disc. Optionally, all or part of the steps in the above embodiments may also be implemented using one or more integrated circuits. Correspondingly, each module unit in the above embodiments may be implemented in the form of hardware or a software functional module, and the present application is not limited to any specific form of combination of software and hardware. The user equipment, terminal, and UE in the present application include but are not limited to: drones, communication modules on drones, remote-controlled aircraft, aircraft, small airplanes, mobile phones, tablet computers, laptops, vehicle-mounted communication devices, transportation tools, vehicles, RSUs (Road Side Units), wireless sensors, network cards, IoT terminals, RFID (Radio Frequency Identification) terminals, NB-IoT (Narrow Band Internet of Things) terminals, MTC (Machine Type Communication) terminals, eMTC (enhanced MTC) terminals, data cards, network cards, low-cost mobile phones, low-cost tablet computers, and other wireless communication devices. The base station or system equipment in the present application includes but is not limited to: macro cell base stations, micro cell base stations, small cell base stations, femtocells, relay base stations, eNBs (evolved Node Bs), gNBs, TRPs, GNSS (Global Navigation Satellite System), relay satellites, satellite base stations, aerial base stations, RSUs, drones, test equipment (e.g., transceivers simulating partial functions of a base station or signaling testers), and other wireless communication devices.

Those skilled in the art should understand that the present invention may be implemented in other specific forms without departing from its core or basic characteristics. Therefore, the currently disclosed embodiments should be regarded as descriptive rather than restrictive in all respects. The scope of the invention is defined by the appended claims rather than the foregoing description, and all modifications within the equivalent meaning and scope thereof are deemed to be included therein.

What is claimed is:

1. A first node for data collection in wireless communications, characterized by comprising:
a first receiver configured to receive a first RRC IE (Radio Resource Control Information Element), the first RRC IE indicates a data collection for a first RS (Reference Signal) resource set; and perform a process of the data collection for the first RS resource set; and
a first transmitter configured to transmit a first information block, the first information block includes a first data set, the first data set depends on measurements performed on the first RS resource set;
wherein executing the process of the data collection for the first RS resource set includes generating data in the first data set; the process of the data collection for the first RS resource set occupies CSI (Channel State Information) processing units in a first time unit set, and the first time unit set includes at least one time unit; a position of the first time unit set in time domain depends on a transmission occasion of the first RS resource set;
wherein the time units included in the first time unit set are periodic; each time unit in the first time unit set starts at a first one of symbols of an earliest RS resource in each given period, and ends at X symbols after a last one of symbols of a latest RS resource in each given period; X is a positive integer greater than 1; the given period depends on a period of the first RS resource set, and the period of the first RS resource set is configured by higher-layer signaling.

2. The first node according to claim 1, wherein an earliest RS resource in the each given period refers to: for a given period, an earliest one of RS resources of the first RS resource set in each transmission occasion; a latest RS resource in the each given period refers to: for a given period, a latest one of RS resources of the first RS resource set in each transmission occasion.

3. The first node according to claim 1, wherein the X time-domain resource elements depend on a capability of the first node.

4. The first node according to claim 1, wherein any RS resource in the first RS resource set is identified by an NZP-CSI-RS-ResourceId or an SSB-Index.

5. A second node for data collection in wireless communications, characterized by comprising:
a second transmitter configured to transmit a first RRC IE, the first RRC IE indicates a data collection for a first RS resource set;
a second receiver configured to receive a first information block, the first information block includes a first data set, the first data set depends on measurements performed on the first RS resource set by a receiver of the first RRC IE;
wherein the receiver of the first RRC IE executes a process of the data collection for the first RS resource set; executing the process of the data collection for the first RS resource set includes generating data in the first data set; the process of the data collection for the first RS resource set occupies CSI processing units in a first time unit set, and the first time unit set includes at least one time unit; a position of the first time unit set in time domain depends on a transmission occasion of the first RS resource set;
wherein the time units included in the first time unit set are periodic; each time unit in the first time unit set starts at a first one of symbols of an earliest RS resource in each given period, and ends at X symbols after a last one of symbols of a latest RS resource in each given period; X is a positive integer greater than 1; the given period depends on a period of the first RS resource set, and the period of the first RS resource set is configured by higher-layer signaling.

6. The second node according to claim 5, wherein an earliest RS resource in the each given period refers to: for a given period, an earliest one of RS resources of the first RS resource set in each transmission occasion; a latest RS resource in the each given period refers to: for a given period, a latest one of RS resources of the first RS resource set in each transmission occasion.

7. The second node according to claim 5, wherein the X time-domain resource elements depend on a capability of the first node.

8. The second node according to claim 5, wherein any RS resource in the first RS resource set is identified by an NZP-CSI-RS-ResourceId or an SSB-Index.

9. A method in a first node for data collection in wireless communications, characterized by comprising:
receiving a first RRC IE, the first RRC IE indicates a data collection for a first RS resource set;
executing a process of the data collection for the first RS resource set;
transmitting a first information block, the first information block includes a first data set, the first data set depends on measurements performed on the first RS resource set;
wherein executing the process of the data collection for the first RS resource set includes generating data in the first data set; the process of the data collection for the first RS resource set occupies CSI processing units in a first time unit set, and the first time unit set includes at least one time unit; a position of the first time unit set in time domain depends on a transmission occasion of the first RS resource set;
wherein the time units included in the first time unit set are periodic; each time unit in the first time unit set starts at a first one of symbols of an earliest RS resource in each given period, and ends at X symbols after a last one of symbols of a latest RS resource in each given period; X is a positive integer greater than 1; the given period depends on a period of the first RS resource set, and the period of the first RS resource set is configured by higher-layer signaling.

10. The method in the first node according to claim 9, wherein an earliest RS resource in the each given period refers to: for a given period, an earliest one of RS resources of the first RS resource set in each transmission occasion; a latest RS resource in the each given period refers to: for a given period, a latest one of RS resources of the first RS resource set in each transmission occasion.

11. The method in the first node according to claim 9, wherein the X time-domain resource elements depend on a capability of the first node.

12. The method in the first node according to claim 9, wherein any RS resource in the first RS resource set is identified by an NZP-CSI-RS-ResourceId or an SSB-Index.

13. A method in a second node for data collection in wireless communications, characterized by comprising:
transmitting a first RRC IE, the first RRC IE indicates a data collection for a first RS resource set; and
receiving a first information block, the first information block includes a first data set, the first data set depends on measurements performed on the first RS resource set by a receiver of the first RRC IE;
wherein the receiver of the first RRC IE executes a process of the data collection for the first RS resource set; executing the process of the data collection for the first RS resource set includes generating data in the first data set; the process of the data collection for the first RS resource set occupies CSI processing units in a first time unit set, and the first time unit set includes at least one time unit; a position of the first time unit set in time domain depends on a transmission occasion of the first RS resource set;
wherein the time units included in the first time unit set are periodic; each time unit in the first time unit set starts at a first one of symbols of an earliest RS resource in each given period, and ends at X symbols after a last one of symbols of a latest RS resource in each given period; X is a positive integer greater than 1; the given period depends on a period of the first RS resource set, and the period of the first RS resource set is configured by higher-layer signaling.

14. The method in the second node according to claim 13, wherein an earliest RS resource in the each given period refers to: for a given period, an earliest one of RS resources of the first RS resource set in each transmission occasion; a latest RS resource in the each given period refers to: for a given period, a latest one of RS resources of the first RS resource set in each transmission occasion.

15. The method in the second node according to claim 13, wherein the X time-domain resource elements depend on a capability of the first node.

16. The method in the second node according to claim 13, wherein any RS resource in the first RS resource set is identified by an NZP-CSI-RS-ResourceId or an SSB-Index.
